(19) United States
(12) Patent Application Publication
(10) Pub. No.: US 2020/0190373 A1
(43) Pub. Date: Jun. 18, 2020

(54) FLUORINATED TACKIFIER FOR PRESSURE SENSITIVE ADHESIVES AND PRESSURE SENSITIVE ADHESIVES ARTICLES

(71) Applicant: 3M INNOVATIVE PROPERTIES COMPANY, St. Paul, MN (US)

(72) Inventors: Jayshree Seth, Woodbury, MN (US); Francois C. D'Haese, Antwerp (BE); Tatsuo Fukushi, Woodbury, MN (US); Tom Opstal, Laarne (BE); David J. Yarusso, Shoreview, MN (US)

(21) Appl. No.: 16/323,274

(22) PCT Filed: Aug. 8, 2017
(86) PCT No.: PCT/US2017/045832

§ 371 Date: Feb. 5, 2019

Related U.S. Application Data
(60) Provisional application No. 62/372,828, filed on Aug. 10, 2016.

(51) Int. Cl. C09J 11/08; C09J 7/38; C09J 127/20

(52) U.S. Cl. CPC C09J 11/08; C08L 33/16; C09J 127/20; C09J 7/38

(57) ABSTRACT

Described herein is a low molecular weight fluorinated (meth)acrylate polymer comprising a plurality of pendent sulfonylamide groups, which is used as a tackifier in a pressure sensitive adhesive composition. Also described herein is a pressure sensitive adhesive composition comprising the low molecular weight fluorinated (meth)acrylate polymer, and articles comprising the pressure sensitive adhesive composition. The pressure sensitive adhesive preferably also comprises a high molecular weight polymer, which is derived from a (meth)acrylate monomer or is a fluoropolymer.

### TECHNICAL FIELD

A low molecular weight fluorinated (meth)acrylate polymer for use as a tackifier in a pressure sensitive adhesive is described along with pressure sensitive adhesive compositions and articles comprising the aforementioned pressure sensitive adhesive.

### SUMMARY

There is a desire to identify alternative pressure sensitive adhesives (PSA). In one embodiment, there is a desire to identify pressure sensitive adhesives that have sufficient adherence to low surface energy substrates such a polyalkylenes, and fluorine-containing surfaces. In one embodiment, there is a desire to identify pressure sensitive adhesives that have improved chemical resistance. In one embodiment, there is a desire to identify pressure sensitive adhesives that have good oil resistance.

In one aspect, the use of a low molecular weight fluorinated (meth)acrylate polymer comprising a plurality of pendent sulfonylamide groups as a tackifier in a pressure sensitive adhesive composition is described.

In another aspect, a pressure sensitive adhesive composition is described comprising:

a high molecular weight polymer; and

10 to 400 parts of a low molecular weight fluorinated (meth)acrylate polymer per 100 parts of the high molecular weight polymer to form a pressure sensitive adhesive, wherein the low molecular weight fluorinated (meth)acrylate polymer comprises a plurality of pendent sulfonylamide groups.

In yet another aspect, a multilayered article is described comprising a pressure sensitive adhesive composition, wherein the pressure sensitive adhesive composition comprises a low molecular weight fluorinated (meth)acrylate polymer comprising a plurality of pendent sulfonylamide groups.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“backbone” refers to the main continuous chain of a polymer;

“copolymer” refers to a polymer derived from two or more different monomers and includes terpolymers, quadpolymers, etc.;

“crosslinking” refers to connecting two pre-formed polymer chains using chemical bonds or chemical groups in order to increase the modulus of the material;

“interpolymerized” refers to monomers that are polymerized together to form the backbone of the polymer;

“(meth)acrylate” refers to compounds containing either an acrylate (CH₂═CHCOOR) or a methacrylate (CH₂═CCH₃COOR) structure or combinations thereof;

“monomer” is a molecule which can undergo polymerization which then form part of the essential structure of a polymer;

“perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, nitrogen atoms, sulfur atoms, chlorine atoms, bromine atoms and iodine atoms.

The term “polymer” as used herein refers to a molecule comprising a chain having at least four interpolymerized monomeric units.

The term “alkyl” refers to a monovalent group that is a radical of an alkane, which is a saturated hydrocarbon. The alkyl can be linear, branched, cyclic, or combinations thereof and typically has 1 to 50 carbon atoms. In some embodiments, the alkyl group contains at least 1, 2, 3, 4, 5, 6, 8, or 10 carbon atoms; at most 50, 40, 30, 28, 26, 25, 20, or 15 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene often has 1 to 50 carbon atoms. In some embodiments, the alkylene group contains at least 1, 2, 3, 4, 5, 6, 8, 10, 15, 20, or 25 carbon atoms; at most 50, 40, 30, 28, 26, 25, 20, 15, 10, 8, 6, 5, 4, or 3 carbon atoms. The radical centers of the alkylene can be on the same carbon atom (i.e., an alkylidene) or on different carbon atoms.

The term “arylene” refers to a divalent group that is a radical of an arene, that has typically, 4, 5, or 6 carbon atoms.

The term “aryl alkylene” refers to a divalent group that comprises both an aromatic group and an alkane group.

The term “aryl” refers to a monovalent group that is aromatic and carbocyclic or heterocyclic. The aryl can have one to five rings that are connected to or fused to the aromatic ring. The other ring structures can be aromatic, non-aromatic, or combinations thereof and typically has 3 to 30 carbon atoms. In some embodiments, the aryl group contains at least 3, 4, 5, 6, 8, 10, 15, 20, or 25 carbon atoms; at most 30, 28, 26, 25, 20, 15, 10, or 8 carbon atoms. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylaryl” refers to a monovalent group that is a combination of an alkyl and an aryl group. The alkylaryl can be an aralkyl, that is, an alkyl substituted with an aryl, or alkaryl, that is, an aryl substituted with an alkyl. The alkylaryl can have one to five rings that are connected to or fused to the aromatic ring and can comprise linear, branched, or cyclic segments, or combinations thereof. The alkylaryl group typically has 4 to 30 carbon atoms. In some embodiments, the alkylaryl group contains at least 4, 5, 6, 8, 10, 15, 20, or 25 carbon atoms; at most 50, 40, 30, 28, 26, 25, 20, 15, 10, or 8 carbon atoms.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

Pressure sensitive adhesives are a type of polymeric composition useful to adhere together two adherends. Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength. Materials that have been found to function well as pressure sensitive adhesives are polymers designed and formulated to exhibit the requisite viscoelastic properties resulting in a desired balance of tack, peel adhesion, and shear holding power.

Conventional pressure sensitive adhesives (PSAs) such as, for example, non-fluorinated acrylate-based adhesives are typically designed for adhesion to either substrates having high surface energy, such as, for example, stainless steel or to substrates having low surface energy, such as, for example, polyolefins. These conventional pressure sensitive adhesives do not adhere well to fluorinated substrates. Fluorinated surfaces are popular due to their inert nature which can, for example, (i) prevent food from sticking to a cooking pan, (ii) prevent stains from adhering to cloth or a digital display surface, or (iii) provide water and oil repellency to porous surfaces.

There is a continuous need for pressure sensitive adhesives that are applicable to a broad range of substrates, including substrates having high and low surface energy. In particular, it is desirable to provide pressure sensitive adhesives that adhere well to fluorine-containing surfaces. In addition or alternatively, in many applications, it is desirable that the pressure sensitive adhesives retain their adhesive properties under harsh conditions (such as chemical resistance, oil resistance, etc.).

The present disclosure is directed toward the use of a low molecular weight fluorinated (meth)acrylate polymer as a tackifier in a pressure sensitive adhesive composition. In particular, it has been discovered that fluorinated (meth)acrylate polymers comprising pendent sulfonylamide groups can be used as a tackifier in acrylate and/or fluoropolymer-based PSAs.

Fluorinated Tackifier

The tackifier of the present disclosure is a low molecular weight fluorinated (meth)acrylate polymer that (i) is derived from (meth)acrylate monomers and (ii) comprises pendent sulfonylamide groups (i.e., —S(═O)₂—N(R)—), which extend from the polymer backbone.

The low molecular weight fluorinated (meth)acrylate polymer comprises a plurality of pendent sulfonylamide groups, in other words comprises at least 2, 3, 5 or even 10 pendent sulfonylamide groups per low molecular weight fluorinated (meth)acrylate polymer.

In one embodiment, the backbone of the low molecular weight fluorinated (meth)acrylate polymer comprises at least 4, or even 5 interpolymerized monomeric units and at most 25, 30, 40, or even 50 interpolymerized monomeric units. In one embodiment, the low molecular weight fluorinated (meth)acrylate polymer has a number average molecular weight (Mn) of at least 0.5, 1, or even 2 kilograms/mole and at most 5, 7.5, or even 10 kilograms/mole. The number average molecular weight may be determined by using gel permeation chromatography, as is known in the art.

The low molecular weight fluorinated (meth)acrylate polymer disclosed herein is fluorinated, meaning that the polymer contains C—F bonds. In one embodiment, at least 10%, 20%, 30%, 40%, 50%, or even 60% of all of the C—H and C—F bonds in the low molecular weight fluorinated (meth)acrylate polymer are C—F bonds. The low molecular weight fluorinated (meth)acrylate polymer may be partially fluorinated (i.e., wherein the backbone comprise at least one C—F bond and at least one C—H bond) or highly fluorinated, wherein the backbone and pendent groups of the polymer comprise C—F bonds and no C—H bonds, however the terminal groups, where the polymerization reaction initiates or terminates, may comprise C—H bonds as a result of the initiator and/or chain transfer agent used in the polymerization reaction.

In one embodiment, the low molecular weight fluorinated (meth)acrylate polymer of the present disclosure is derived from at least 50, 60, 70, 80, 85 or even 90 mole % or even 100 mole % of a monomeric unit comprising a pendent sulfonylamide group.

In one embodiment, the low molecular weight fluorinated (meth)acrylate polymer comprises an interpolymerized segment according to formula I:

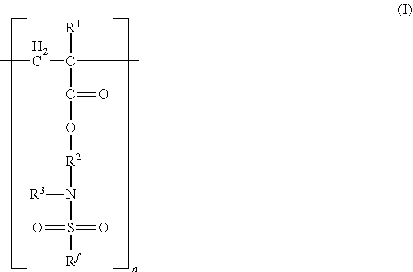

wherein R¹ is H or CH₃; R² is a linking group; R³ is H or an alkyl group; R_{f} comprises a fluorinated group; and n is at least 2.

R₂ in Formula I is a linking group, linking the ester from the (meth)acryl group with the sulfonylamide moiety. In one embodiment, R₂ comprises at least one of an alkylene, a carbamate group, an ether group, an ester group, a urea group, and combinations thereof. The carbamate, ether, ester, and urea group may further comprise an alkylene, arylene, or aryl alkylene. Exemplary R₂ groups include: —CH₂—; —C₂H₄—; —C₃H₆—; —C₄H₈—; —C₂H₄₀—C(═O)NH—(C₆H₄)—CH₂—(C₆H₄)CH₂CO₂C₂H₄—; —C₂H₄—OC(═O)NH—(C₆H₃CH₃)—NHCO₂C₂H₄—; —C₂H₄NHCO₂C₂H₄—; —(C₂H₄O)ᵥ- wherein v is 1-5; and —C₂H₄NHC(═O)—.

R^{f} is a perfluorinated alkyl or perfluorinated aryl group, comprising 1 to 20 carbon atoms. Exemplary R^{f} groups include: —CF₃; —C₂F₅; —C₃F₇; —C₄F₉; —C₅F₁₁; —C₆F₁₃; —C₈F₁₇; —C₉F₁₉; —C₁₂F₂₅; —C₂₀F₄₁; and —C₆F₅.

In one embodiment, in addition to the interpolymerized segment comprising a pendent sulfonylamide group (such as an interpolymerized segment according to Formula (I)), the low molecular weight fluorinated (meth)acrylate polymer may comprise additional monomeric units randomly polymerized into the backbone of the low molecular weight polymer. These additional monomeric units may be incorporated into the low molecular weight fluorinated (meth)acrylate polymer to modify its properties.

Exemplary monomers interpolymerized with a monomer comprising pendent sulfonylamide group include: (meth)acrylates such as polyalkyleneoxy (meth)acrylate, cyclohexyl (meth)acrylate, methyl methacrylate, and isobornyl (meth)acrylate; (meth)acryloyl-containing monomers such as acryloyl benzophenone and para-acryloxyethoxybenzophenone; hydroxyl-containing monomers such as a reaction product of acrylic acid and a glycidyl ester of versatic acid commercially available under the trade designation “ACE HYDROXYLACRYLATE MONOMER” from Hexion Specialty Chemicals, Belgium, 4-hydroxybutyl acrylate commercially available from BASF AG, Germany and 2-hydroxy-3-phenoxypropyl acrylate from Shin Nakamura, Japan; carboxyl-containing monomers such as (meth)acrylic acid, itaconic acid, fumaric acid, crotonic acid, citraconic acid, and maleic acid, beta-carboxyethylacrylate; and nitrogen-containing monomers such as amine functional and amide functional monomers, such as N,N-dialkylaminoalkyl (meth)acrylates, N,N-dialkyl(meth)acrylamide, N-vinyl-2-pyrrolidone, N-vinyl caprolactam, and acrylonitrile; vinyl esters such as vinyl acetate, and those commercially available under the trade designations “VEOVA-EH”, “VEOVA 9” and “VEOVA 10” from Momentive Specialty Chemicals Inc., Columbus, Ohio; and combinations thereof.

To function as a tackifier, the low molecular weight fluorinated (meth)acrylate polymer of the present disclosure should decrease the plateau shear modulus of the composition relative to the high molecular weight polymer and modify the glass transition temperature (Tg) of the composition relative to that of the high molecular weight polymer. In one embodiment, the low molecular weight fluorinated (meth)acrylate polymer of the present disclosure should have a glass transition temperature of at least −15° C., −10° C., −5° C., or even −1° C.; and at most 40° C., 35° C., or even 30° C. Unless otherwise mentioned, the Tg values of the materials disclosed herein are measured by DSC (differential scanning calorimetry) following methods known in the art, for example, ASTM D7426: Standard Test Method for Assignment of the DSC Procedure for Determining Tg of a Polymer or an Elastomeric Compound (D7426-08, reapproved 2013).

The low molecular weight fluorinated (meth)acrylate polymer is derived from the polymerization of a first monomer comprising a pendent sulfonylamide group. In one embodiment, the first monomer is a (meth)acrylate monomer comprising a pendent sulfonylamide group. In another embodiment, the first monomer comprises a pendent sulfonylamide group, while a second monomer is a (meth)acrylate monomer. As mentioned above, additional monomers may be interpolymerized with the first monomer and optionally, the second monomer, to form the low molecular weight fluorinated (meth)acrylate polymer of the present disclosure.

The low molecular weight fluorinated (meth)acrylate polymer of the present disclosure can be prepared, for example, by free radical initiated polymerization of the first monomer comprising a pendent sulfonylamide group along with any comonomers. Exemplary first monomers that can be polymerized to make the low molecular weight fluorinated (meth)acrylate polymer include:

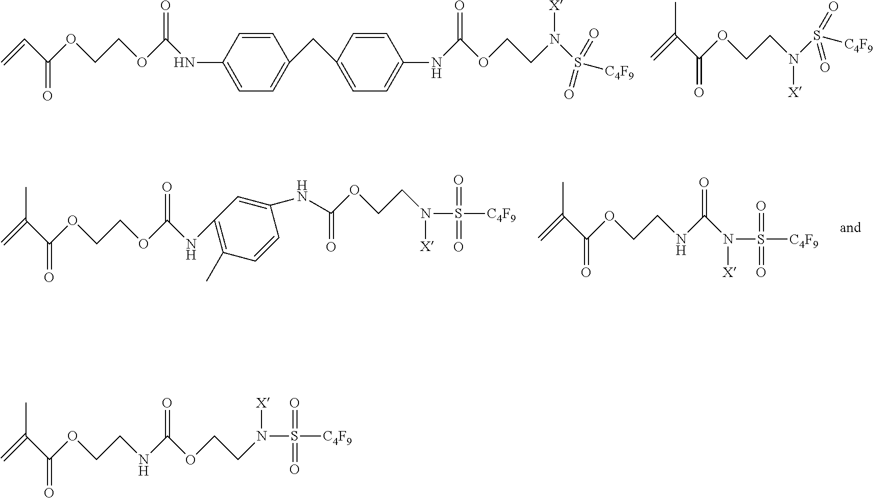

wherein X′ is CH₃ or H.

Such free radical polymerizations are known in the art. By adjusting the concentration of the monomers, the concentration and activity of the initiator, the temperature, and the chain-transfer agent used, if any, the molecular weight of the low molecular weight fluorinated (meth)acrylate polymer can be controlled. Such low molecular weight fluorinated (meth)acrylate polymer and methods of making are disclosed in U.S. Pat. No. 7,047,379 (Jariwala et al.), herein incorporated by reference.

The low molecular weight fluorinated (meth)acrylate polymers of the present disclosure are combined with at least a high molecular weight polymer to provide the pressure sensitive adhesive composition. Exemplary high molecular weight polymers include, acrylate polymers, fluorinated polymers, silicone polymers, hydrocarbon rubbers, polyvinyl ethers, polyolefins, polyesters, polyurethane, and combinations and blends thereof.

(Meth)acrylate Polymer

In one embodiment, the high molecular weight polymer is a (meth)acrylate polymer containing a polymerized form of at least one linear or branched alkyl (meth)acrylate monomer, wherein the linear or branched alkyl group of the alkyl (meth)acrylate monomer preferably comprises from 1 to 24, more preferably from 4 to 20, even more preferably 6 to 18, still more preferably from 8 to 12 carbon atoms. As used herein, the “high molecular weight (meth)acrylate polymer” will be referred to interchangeably as an “acrylate polymer”, unless otherwise noted. The acrylate polymer can be prepared by polymerizing a mixture of the above-mentioned monomers by any suitable method known in the art.

In a preferred aspect, at least one linear or branched alkyl (meth)acrylate monomer is selected from the group consisting of methyl acrylate; ethyl acrylate; propyl acrylate, such as n-propyl acrylate and isopropyl acrylate; butyl acrylate, such as n-butyl acrylate and isobutyl acrylate; pentyl acrylate, such as n-pentyl and iso-pentyl acrylate; hexyl acrylate, such as n-hexyl acrylate and iso-hexyl acrylate; octyl acrylate, such as iso-octyl acrylate, 2-octyl acrylate, and 2-ethylhexyl acrylate; nonyl acrylate; decyl acrylate, such as 2-propylheptyl acrylate; dodecyl acrylate; lauryl acrylate; octadecyl acrylate, such as C18 acrylate derived from Guerbet alcohols, which can be 2-heptyl undecanyl acrylate; and any combinations or mixtures thereof.

Typically, the acrylate polymer is prepared from a monomer mixture comprising from 50 to 100 parts, from 70 to 100 parts, from 80 to 100 parts, or even from 90 to 100 parts by weight of at least one linear or branched alkyl (meth)acrylate monomer, wherein the linear or branched alkyl group of the alkyl (meth)acrylate monomer preferably comprises from 1 to 24, more preferably from 4 to 20, even more preferably 4 to 18, still more preferably from 4 to 12 carbon atoms.

In one embodiment, one or more of acrylic acid, methacrylic acid or any other monomers bearing an acid moiety can be included in the acrylate polymer as well, however, typically at amounts no more than 10%, 8%, 6%, 5%, 4%, 3%, 2%, 1.5%, 1%, or even 0.5% by weight based on the total weight of the acrylate polymer. In one embodiment, the acrylate polymer is free of monomers bearing an acid moiety.

In one embodiment, one or more of unsaturated co-monomers bearing a basic moiety can be included in the acrylate polymer as well, however, typically at amounts no more than 10%, 8%, 6%, 5%, 4%, 3%, 2%, 1.5%, 1%, or even 0.5% by weight based on the total weight of the acrylate polymer. In one embodiment, the acrylate polymer is free of monomers bearing a basic moiety. Exemplary monomers bearing a basic moiety include for example N,N-dialkyl(meth)acrylamide, N,N-dialkylaminoalkyl (meth)acrylates, N-vinyl-2-pyrrolidone, N-vinyl caprolactam, (meth)acrylonitrile, (meth)acrylamide, and combinations thereof.

Typically, the amount of co-monomers containing an acidic or basic moiety used in the acrylate polymer should be kept low to avoid incompatibility of the acrylate polymer with the low molecular weight fluorinated (meth)acrylate polymer.

To function as a tackifier, the low molecular weight fluorinated (meth)acrylate polymer needs to be at least partially soluble in the high molecular weight polymer. Preferably the tackifier is completely soluble in the high molecular weight polymer. To be an effective tackifier, the low molecular weight fluorinated (meth)acrylate polymer reduces the plateau modulus and raises the Tg of the mixture relative to the Tg of high molecular weight polymer.

In one embodiment, one or more other monoethylenically unsaturated co-monomers may be present in the monomer mixture used to prepare the acrylate polymer, in an amount of from 0.5 to 50 parts co-monomer, and are thus typically polymerized with the acrylate monomers. Examples of suitable co-monomers include cyclohexyl (meth)acrylate, vinyl acetate, isobornyl (meth)acrylate, hydroxyalkyl (meth)acrylates, vinyl esters of neodecanoic, neononanoic, neopentanoic, 2-ethylhexanoic, or propionic acids (e.g., available from Union Carbide Corp., Danbury, Conn. under the trade designation “VYNATES”), vinylidene chloride, alkyl vinyl ethers, ethoxyethoxy ethyl acrylate and methoxypolyethylene glycol 400 acrylate (available from Shin Nakamura Chemical Co. Ltd., Wakayama, Japan, under the trade designation “NK ESTER AM-90G”), and any combinations or mixtures thereof. When present, the other monoethylenically unsaturated co-monomer is typically used in amounts ranging from 0.5 to 25, from 1.0 to 15, from 1.0 to 8.0, from 2.0 to 6.0, or even from 3.0 to 5.0 parts, by weight per 100 parts by weight of the high molecular weight acrylate polymer.

In one embodiment, a fluorinated (meth)acrylate monomer is polymerized into the high molecular weight (meth)acrylate polymer to increase the compatibility of the fluorinated tackifier with the acrylate polymer. Such amounts may include up to 10, 20, or even 30 wt % based on the weight of the high molecular weight polymer. The fluorinated (meth)acrylate monomer is preferably an fluorinated acrylate monomer. Exemplary fluorinated co-monomers include 2,2,2,-trifluoroethyl (meth)acrylate, 4,4,4,3,3,2,2 heptafluoro(meth)acrylate, N-methyl perfluorobutylsulphonamidoethylacrylate, CF₃(CF₂)₃(CH₂)₂OCOCH═CH₂, and CF₃(CF₂)₅(CH₂)₂OCOCH═CH₂.

Generally, the monomer mixture used to prepare the high molecular weight (meth)acrylate polymer, includes an appropriate initiator. For polymerization by ultraviolet light, a photoinitiator is included. Useful photoinitiators include substituted acetophenones such as benzyl dimethyl ketal and 1-hydroxycyclohexyl phenyl ketone, substituted alpha-ketols such as 2-methyl-2-hydroxypropiophenone, benzoin ethers such as benzoin methyl ether, benzoin isopropyl ether, substituted benzoin ethers such as anisoin methyl ether, aromatic sulfonyl chlorides, photoactive oximes and azo-type initiators. The photoinitiator may be used in an amount from about 0.001 to about 5.0 parts by weight, preferably from about 0.01 to about 3.0 parts by weight, more preferably in an amount from 0.05 to 0.5 parts by weight, and more preferably in an amount from 0.05 to 0.3 parts by weight per 100 parts by weight of total monomer.

The monomer mixture used to prepare the high molecular weight (meth)acrylate polymer, may also be polymerized by thermal polymerization or by a combination of thermal and radiation polymerization. For thermal polymerization, a thermal initiator is included. Thermal initiators useful in the present invention include, but are not limited to azo, peroxide, persulfate, and redox initiators. Azo-type initiators, such as e.g. the “Vazo” line, commercially available from The Chemours Co., are particularly preferred. The thermal initiator may be used in an amount from about 0.01 to about 5.0 parts by weight per 100 parts by weight of total monomer, preferably from 0.025 to 2 weight percent.

In one embodiment the high molecular weight (meth)acrylate polymer has a Tg of at least −70, −60, or even −50° C.; and at most 0, −10, −20, or even −30° C.

In one embodiment of the present disclosure, the acrylate polymer may or may not be crosslinked. In one embodiment, crosslinking may be used to improve the thermal shear strength of the PSA. The crosslinking agent used to crosslink the polymer would depend on the cure-sites present in the acrylate polymer. Useful crosslinking agents include: multifunctional (meth)acrylates, multifunctional aziridines, polycarbodiimides, triazines, and combinations thereof. Exemplary crosslinking agents include substituted triazines such as 2,4,-bis(trichloromethyl)-6-(4-methoxy phenyl)-s-triazine, 2,4-bis(trichloromethyl)-6-(3,4-dimethoxyphenyl)-s-triazine, and the chromophore-substituted halo-s-triazines disclosed in U.S. Pat. Nos. 4,329,384 and 4,330,590 (Vesley). Examples of useful multifunctional (meth)acrylates included alkyl (meth)acrylates such as trimetholpropane triacrylate, pentaerythritol tetra-acrylate, 1,2 ethylene glycol diacrylate, 1,4 butanediol diacrylate, 1,6 hexanediol diacrylate, and 1,12 dodecanol diacrylate.

In one embodiment, the crosslinking agent comprises a polymeric UV crosslinkable polymer as disclosed in U.S. Pat. Publ. No. 2015291853 (D'Haese) herein incorporated by reference.

In one embodiment, the high molecular weight (meth)acrylate polymer has a number average molecular weight (Mn) of at least 20; 25; 40; 50; 100; 300; 500; 750; 1000; or even 1500 kilograms/mole.

Fluorinated Polymer

In one embodiment, the high molecular weight polymer is a fluorinated polymer. The fluorinated polymer may be derived from one or more fluorinated monomer(s) such as fluorinated olefins, fluorinated vinyl ethers, and fluorinated allyl ethers. Exemplary fluorinated monomers include: tetrafluoroethylene (TFE), vinyl fluoride (VF), vinylidene fluoride (VDF), hexafluoropropylene (HFP), pentafluoropropylene, trifluoroethylene, trifluorochloroethylene (CTFE), CF₃CF═CH₂, fluoro ether monomer, and combinations thereof.

Such fluoro ether monomers include those of Formula (II)

CF₂═CF(CF₂)_{b}O(R_{f″}O)ₙ(R_{f′}O)ₘR_{f} (II)

where R_{f}, and R_{f}, are independently linear or branched fluoroalkylene groups comprising 2, 3, 4, 5, or 6 carbon atoms, b is 0 or 1, m and n are independently an integer selected from 0, 1, 2, 3, 4, 5, 6, 7, 8, 9, and 10, and R_{f} is a fluoroalkyl group comprising 1, 2, 3, 4, 5, or 6 carbon atoms. Exemplary perfluorinated vinyl ether monomers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, perfluoro-methoxy-methylvinylether (CF₃—O—CF₂—O—CF═CF₂), and CF₃—(CF₂)₂—O—CF(CF₃)—CF₂—O—CF(CF₃)—CF₂—O—CF═CF₂, perfluoro (methyl allyl) ether (CF₂═CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂, CF₂═CFOCF₂OCF₂CF₃, CF₂═CFOCF₂OC₃F₇, and combinations thereof.

Partially fluorinated ether monomers include those of Formula (III);

CXX═CX(CYY)_{b}O(R_{f″}O)ₙ(R_{f′}O)ₘR_{f} (III)

where X is independently selected from H or F; Y is H, F, CF₃; R_{f}, and R_{f} are independently linear or branched fluoroalkylene radical groups comprising 2, 3, 4, 5, or 6 carbon atoms, b is 0 or 1, m and n are independently an integer selected from 0, 1, 2, 3, 4, 5, 6, 7, 8, 9, and 10, and R_{f} is a fluoroalkyl group comprising 1, 2, 3, 4, 5, or 6 carbon atoms.

Exemplary partially fluorinated ether monomers include for example:

CF₃—O—CH═CF₂, CF₃—O—CF═CFH, CF₃—O—CH═CH₂, CF₃—O—CF₂—CF═CH₂, CF₃—O—CF₂—CH═CH₂, CF₃—CH₂—O—CF₂—CF═CF₂, HCF₂—CH₂—O—CF₂—CF═CF₂, HCF₂—CF₂—CF₂—O—CF═CF₂, HCF₂—CF₂—CF₂—O—CF—CF═CF₂, CF₃—CFH—CF₂—O—CF═CF₂, and combinations thereof.

In one embodiment, additional monomers may be interpolymerized with the fluorinated monomers described above, including for example, non-fluorinated monomers, such as ethene, propene, and butene; other fluorinated monomers; and cure site monomers. Generally, these additional monomers would be used at less than 20, 10, 5, or even 2 mole percent in the fluoropolymer.

Exemplary fluoropolymers include: a TFE/propylene copolymer, a TFE/propylene/VDF copolymer, a VDF/HFP copolymer, a TFE/VDF/HFP copolymer, a TFE/PMVE copolymer, a TFE/CF₂═CFOC₃F₇ copolymer, a TFE/CF₂═CFOCF₃/CF₂═CFOC₃F₇ copolymer, a TFE/ethyl vinyl ether (EVE) copolymer, a TFE/butyl vinyl ether (BVE) copolymer, a TFE/EVE/BVE copolymer, a VDF/CF₂═CFOC₃F₇ copolymer, an ethylene/HFP copolymer, a TFE/HFP copolymer, a CTFE/VDF copolymer, a TFE/VDF copolymer, a TFE/ethylene/PMVE copolymer, a TFE/VDF/PMVE/ethylene copolymer, and a TFE/VDF/CF₂═CFO(CF₂)₃OCF₃ copolymer.

Cure site monomers are polymerized into the polymer and introduce cure sites into the fluorinated polymers for subsequent crosslinking reactions. As described above, crosslinking may be used to improve the thermal shear strength of the PSA.

Exemplary halogenated cure site monomers may be represented by one or more compounds of the formula: CXX═CX(Z), wherein: (i) each X is independently H or F; and (ii) Z is I, Br, R_{f}—U wherein U=I or Br and R_{f}=a perfluorinated or partially perfluorinated alkylene group optionally containing oxygen atoms. In addition, non-fluorinated bromo- or iodo-olefins, e.g., vinyl iodide and allyl iodide, can be used. In some embodiments, the cure site monomers are one or more compounds selected from the group consisting of CH₂═CHI, CF₂═CHI, CF₂═CFI, CH₂═CHCH₂I, CF₂═CFCF₂I, CH₂═CHCF₂CF₂I, CF₂═CFCH₂CH₂I, CF₂═CFCF₂CF₂I, CH₂═CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃—OCF₂CF₂I, CH₂═CHBr, CF₂═CHBr, CF₂═CFBr, CH₂═CHCH₂Br, CF₂═CFCF₂Br, CH₂═CHCF₂CF₂Br, CF₂═CFOCF₂CF₂Br, CF₂═CFCl, CF₂═CFCF₂Cl, and a combination thereof.

Exemplary nitrile-containing cure site monomers include perfluoro(8-cyano-5-methyl-3,6-dioxa-1-octene); CF₂═CFO(CF₂)_{L}CN wherein L is an integer from 2 to 12; CF₂═CFO(CF₂)ᵤOCF(CF₃)CN wherein u is an integer from 2 to 6; CF₂═CFO[CF₂CF(CF₃)O]_{q}(CF₂O)_{y}CF(CF₃)CN wherein q is an integer from 0 to 4 and y is an integer from 0 to 6; or CF₂═CF[OCF₂CF(CF₃)]ᵣO(CF₂)ₜCN wherein r is 1 or 2, and t is an integer from 1 to 4; and derivatives and combinations of the foregoing.

Exemplary hydroxy-containing cure site monomers may be represented by the formula: CXX═CX(CXX)_{q}-(O)ₙ-(CXX)ₘ-(O)ₚ-(CHZ)ₛ-(CYY)ᵣ-CH₂OH wherein each X is independently selected from H or F; q is 0 or 1; n is 0 or 1; Z is either a OH, a C1-C5 alkyl group comprising a hydroxyl group, or a C1-C5 fluorinated alkyl group comprising a hydroxyl group; each Y is a H, F, an alkyl group, or a fluorinated alkyl group; m is an integer from 0-10; p is 0 or 1; s is an integer from 0-2; and r is an integer from 0-10. Exemplary fluorinated hydroxy-containing cure site monomers include: CF₂═CF—O—(CF₂)ₜ-CH₂OH and CF₂═CF—CF₂—O—(CF₂)ₜ-CH₂OH where t is an integer from 1-5. Exemplary nonfluorinated hydroxy-containing cure site monomers include: CH₂═CH—O—(CH₂)ᵥ-OH, CH₂═CH—CH₂—O—(CH₂)ᵥ-OH, and CH₂═CH—(CH₂)ᵥ-OH, where v is an integer from 1-6.

Exemplary acid- or ester-containing cure site monomers may be represented by the formula CXX═CX(CXX)_{q}-(O)ₙ-(CXY)ₘ-(O)ₚ-(CXQ)ₛ-(CYY)ᵣ-Q wherein each X is independently selected from H or F; each Y is a H, F, an alkyl group, or a fluorinated alkyl group; q is 0 or 1; n is 0 or 1; m is an integer from 0-10; p is 0 or 1; s is an integer from 0-2; r is an integer from 0-10; and Q is selected from COO⁻¹, COOR, wherein R is a linear or branched alkyl group comprising 1 to 5 carbons, SO₂F, SO₃⁻¹, NH₂, N₃, and SO₂NH₂, an a alkyl group comprising COO⁻¹, COOR, SO₂F, SO₃⁻¹, NH₂, N₃, or SO₂NH₂, or a fluorinated group alkyl group comprising COO⁻¹, COOR, SO₂F, SO₃⁻¹, NH₂, N₃, or SO₂NH₂ as previously described. Exemplary monomers include CF₂═CF—[O—CF(CF₃)CF₂]_{b}-O—(CF₂)_{c}-Q where b is 0 or 1 and c is an integer of 1-10; CF₂═CF—CF₂—[O—CF(CF₃)CF₂]_{d}-O—(CF₂)_{c}-Q where d is an integer from 0-2 and c is an integer of 1-10; CH₂═CH—COOH; CH₂═CH—COOR where R is defined above; CH₂═CH—O—(CH₂)_{c}-COOH where c is defined above; CH₂═CH—O—(CH₂)_{c}-COOR where c and R are defined above; CH₂═CH—O—(CH₂)_{c}-SO₃H where c is defined above; CH₂═CH—O—(CH₂)_{c}-SO₂NH₂ where c is defined above; CH₂═CH—CH₂—O—(CH₂)_{c}-COOH where c is defined above; CH₂═CH—CH₂—O—(CH₂)_{c}-COOR where c and R are defined above; CH₂═CH—CH₂—O—(CH₂)_{c}-SO₃H where c is defined above; CH₂═CH—CH₂—O—(CH₂)_{c}-SO₂NH₂ where c is defined above; and CH₂═CH—O—C₆H₄-Q where Q is defined above.

Exemplary olefinic cure site monomers may be represented by the formula: CXX═CX(CXX)_{q}-(O)ₙ-(CXY)ₘ(O)ₚ-(CXX)ₛ-(CXX)ᵣ-CX═CXX wherein each X is independently selected from H or F; Y is a H, F, an alkyl group, or a fluorinated alkyl group; q is 0 or 1; n is 0 or 1; m is an integer from 0-10; p is 0 or 1; s is an integer from 0-2; and r is an integer from 0-10. Exemplary monomers include CF₂═CF—O—(CF₂)ₐ-O—CF═CF₂, CF₂═CF—CF₂—O—(CF₂)ₐ-O—CF₂—CF═CF₂, CF₂═CF—O—(CF₂)ₐ-CH═CH₂, CH₂═CH—(CF₂)ₐ-CH═CH₂, CF₂═CF—O—(CF₂)ₐ-O—CF₂—CF═CF₂, CH₂═CH—O—(CH₂)ₐ-CH═CH₂, and CH₂═CH—O—(CH₂)ₐ-O—CH═CH₂ where a is an integer from 1-10.

Exemplary amine and azide cure site monomers may be represented by the formula CXX═CX(CXX)_{q}-(O)ₙ-(CXY)ₘ-(O)ₚ-(CXZ′)ₛ-(CYY)ᵣ-Z′ wherein each X is independently selected from H or F; each Y is a H, F, an alkyl group, or a fluorinated alkyl group; q is 0 or 1; n is 0 or 1; m is an integer from 0-10; p is 0 or 1; s is an integer from 0-2; r is an integer from 0-10; and Z′ is selected from an amine or an azide. Exemplary monomers include: CH₂═CH—O—(CH₂)ₐ-NH₂, CH₂═CH—CH₂—O—(CH₂)ₐ-NH₂, CH₂═CH—(CH₂)ₐ-NH₂, CH₂═CH—O—C₆H₄—NH₂, CF₂═CF—O—(CF₂)ₐ—(CH₂)_{c}NH₂, CF₂═CF—CF₂—O—(CF₂)ₐ-(CH₂)_{c}-NH₂, CF₂═CF₂—O—(CF—CF₂)_{b}-(CF₂)ₐ-(CH₂)—NH₂, CH₂═CH—O—(CH₂)ₐ-N₃, CH₂═CH—CH₂—O—(CH₂)ₐ-N₃, CH₂═CH—(CH₂)ₐ-N₃, CH₂═CH—O—C₆H₄—N₃, CF₂═CF—O—(CF₂)ₐ-N₃, CF₂═CF—O—(CF₂)ₐ-(CH₂)_{c}-N₃, CF₂═CF—CF₂—O—(CF₂)ₐ-N₃, CF₂═CF—CF₂—O—(CF₂)ₐ-(CH₂)_{c}-N₃, and CF₂═CF—O—(CF(CF₃)—CF₂)_{b}-O—(CF₂)ₐ-(CH₂)_{d}-N₃, where a is an integer from 1-6, b is an integer from 0-2, c is an integer from 1-4, and d is an integer from 0-4.

If crosslinking of the fluoropolymer is desired, the fluoropolymer may contain a sufficient quantity of cure-site groups which can act as cure sites for crosslinking reactions. Typically, the fluoropolymer comprises from at least about 0.05, 0.1, or even 0.5 mole percent and no more than about 10, 5 or even 2 mole percent cure site monomer versus the total fluoropolymer.

Chain transfer agents may be added during the polymerization to control the molecular weight and optionally introduce cures sites into the fluorinated polymer. Chain transfer agents may include for example, alkanes such as ethane and n-pentane, dialkyl ethers such as dimethyl ether, methyl tertiary butyl ether, thiols, or compounds having the formula R_{f}Yₓ, wherein R_{f} is an x-valent (per)fluoroalkyl radical C1-C12, optionally containing chlorine atoms, while x is 1 or 2 and Y represents Br, Cl or I. Examples include perfluoroalkyl-chloride, bromide or iodides. Examples of suitable chain transfer agents include CF₂Br₂, Br(CF₂)₂Br, Br(CF₂)₄Br, CF₂ClBr, CF₃CFBrCF₂Br and the like. Further examples of suitable chain transfer agents include CH₂Br₂ and those disclosed in U.S. Pat. No. 4,000,356. Other suitable chain transfer agents are iodine containing chain transfer agents such as CH₂I₂, CF₂I₂, ICF₂CF₂CF₂CF₂I, CF₃I, CH₃I and the like. If the chain transfer agent comprises I or Br, these atoms may be incorporated into the fluoropolymer, which can act as cure-sites as well. For example, suitable iodo-chain transfer agent in the polymerization include the formula of RIₓ, where (i) R is a perfluoroalkyl or chloroperfluoroalkyl group having 3 to 12 carbon atoms; and (ii) x=1 or 2. The iodo-chain transfer agent may be a perfluorinated iodo-compound. Exemplary iodo-perfluoro-compounds include 1,3-diiodoperfluoropropane, 1,4-diiodoperfluorobutane, 1,6-diiodoperfluorohexane, 1,8-diiodoperfluorooctane, 1,10-diiodoperfluorodecane, 1,12-diiodoperfluorododecane, 2-iodo-1,2-dichloro-1,1,2-trifluoroethane, 4-iodo-1,2,4-trichloroperfluorobutan, and mixtures thereof. In some embodiments, the bromine is derived from a brominated chain transfer agent of the formula: RBrₓ, where (i) R is a perfluoroalkyl or chloroperfluoroalkyl group having 3 to 12 carbon atoms; and (ii) x=1 or 2. The chain transfer agent may be a perfluorinated bromo-compound.

Exemplary commercially available high molecular weight fluorinated polymers include those available under the trade designations: “3M DYNEON FLUOROELASTOMER FC 1610N”, “3M DYNEON FLUOROELASTOMER FPO 3520”, “3M DYNEON FLUOROELASTOMER FPO 3630”, “3M DYNEON FLUOROELASTOMER FC 2178”, and “3M DYNEON FLUOROELASTOMER LTFE 6350Z” available from 3M Company, St. Paul, Minn.; “VITON A100”, “VITON A200”, and “VITON A500” available from The Chemours Co., Wilmington, Del.; and “DAI-EL G-211” available from Diakin Industries LTD., Osaka, Japan; and “TECNOFLON N 215U”, “TECNOFLON N 535”, and “TECNOFLON N 935” available from Solvay S.A., Brussels, Belgium.

The fluorinated polymers can be prepared by polymerization of appropriate fluorinated monomer mixtures in the presence of a free radical generating initiator either in bulk, in solution in a solvent (such as a tertiary butanol solvent or halogenated solvents such as fluorinated solvents e.g., sold under the trade name “3M FLUORINERT ELECTRONIC LIQUID” and “3M NOVEC ENGINEERED FLUID from 3M Co., St. Paul, Minn.), in aqueous suspension, or in aqueous emulsion. Such polymerization techniques are known in the art. In one embodiment the polymerizations are carried out in an aqueous medium by feeding monomers under pressure into a stirred reactor and initiating the polymerization. The polymerization systems may comprise auxiliaries, such as buffers and, if desired, complex-formers or chain-transfer agents.

Initiator systems that may be used to initiate the free radical polymerization include initiator systems that generate free radicals through a redox reaction such as for example a combination of an oxidizing agent and a reducing agent (e.g., a perfluoroalkyl sulfinate and a suitable oxidizing agent capable of oxidizing the perfluoroalkyl sulfinate to a perfluoroalkyl sulfonyl radical, which subsequently generates a perfluoroalkyl radical). Suitable oxidizing agents for this purpose include persulfates, including for example, ammonium persulfate, potassium persulfate, and sodium persulfate. Other oxidizing agents such as bromate, chlorate and hypochlorite, as described in U.S. Pat. No. 5,639,837 (Farnham et al.), may also be used. A particularly useful class of reducing agents are perfluoroalkyl sulfinates, but other reducing agents may also be present, such as a sulfite, e.g., sodium sulfite, sodium bisulfite; a metabisulfite, e.g., sodium or potassium bisulfite; pyrosulfites; and thiosulfates. Additionally, Na₂S₂O₅, and metal ions such as copper, iron, and silver may be used. The amount of initiator employed is typically between 0.03% and 2% by weight, preferably between 0.05% and 1% by weight based on the total weight of the polymerization mixture.

In one embodiment, at least 10%, 20%, 30%, 40%, 50%, 60%, or even 70% of all of the C—H and C—F bonds in the fluorinated polymer are C—F bonds. The fluorinated polymer may be partially fluorinated (i.e., comprising C—F and C—H bonds) or highly fluorinated, wherein the backbone of the fluoropolymer comprise C—F bonds and no C—H bonds, however the terminal groups, where the polymerization reaction initiates and terminates may comprise C—H bonds as a result of the initiator and/or chain transfer agent used in the polymerization reaction.

As mentioned above, for the low molecular weight (meth)acrylate polymer to be a tackifier in a high molecular weight polymer, the low molecular weight (meth)acrylate polymer needs to be at least partially soluble, forming a single phase, such that the low molecular weight fluorinated (meth)acrylate polymer reduces the plateau modulus and changes the Tg of the mixture relative to the Tg of the high molecular weight polymer. In one embodiment the high molecular weight fluorinated polymer has at least one Tg of at least −70, −60, or even −50° C.; and at most 0, −5, −10, −15, −20, or even −30° C.

In one embodiment of the present disclosure, the fluoropolymer is an amorphous polymer which may or may not be crosslinked. The crosslinking agent used to crosslink the polymer would depend on the cure-site present. For example, when comprising a nitrile or halogen, crosslinking of the amorphous polymer to generate a fluoroelastomer can be performed generally with a peroxide, a silyl, a polyol or a polyamine, or an appropriate catalyst. When the cure-site comprises an azide, a crosslinking agent comprising an alkyne can be used. When the cure-site comprises an alcohol, an (iso)cyanate-, acid-, ester-, or olefin-containing crosslinking system can be used. When the cure-site comprises a vinyl group, a cure system comprising polyalcohols, polyamines, or alcohol containing amines can be used. When the cure-site comprises a nitrile, a curing system comprising azides, amines, including polyamines, aminophenols and aminoalcohols, or ammonia generating compounds can be used. When the cure site comprises an ester, curing systems comprising polyalcohols or polyamines are suitable. Such cure systems are known in the art.

An amorphous fluoropolymer has an absence of long-range order, wherein long-range order means that the arrangement and orientation of the macromolecules beyond their nearest neighbors is understood. Typically, an amorphous fluoropolymer has no detectable crystalline character by DSC. In other words, the amorphous fluoropolymer would have no melting point or melt transitions with an enthalpy more than 2 milliJoules/g by DSC.

In another embodiment of the present disclosure, the fluoropolymer is a fluoro-thermoplastic elastomer, comprising hard segments and soft segments, such as those disclosed in U.S. Pat. Publ. No. 2015/0240134 (Keite-Telgenbuscher, et al.) and EP 0399543 (Tatemoto). Such fluoropolymers include a fluorine-containing elastomer having at least one soft segment, composed of a terpolymer of vinylidene fluoride/hexafluoropropylene/tetrafluoroethylene or vinylidene fluoride/chlorotrifluoroethylene/tetrafluoroethylene, and at least one hard segment, composed of a copolymer of tetrafluoroethylene/ethylene or chlorotrifluoroethylene/ethylene or polyvinylidene fluoride; a fluorine-containing elastomer having at least one soft segment composed of a copolymer of tetrafluoroethylene/propylene and at least one hard segment composed of a copolymer of tetrafluoroethylene/ethylene; and/or a fluorine-containing elastomer having at least one soft segment composed of an amorphous rubberlike copolymer of tetrafluoroethylene/perfluoroalkyl vinyl ether and at least one hard segment composed of a copolymer of tetrafluoroethylene/perfluoroalkyl vinyl ether in which the amount of perfluoroalkyl vinyl ether is less than in the soft segment. Such commercially available fluoropolymers include those under the trade designation “DAI-EL THERMOPLASTIC T-500” series, such as T-530 and T-550 and “DAI-EL G-7000” series, such as G-7400EBP and G-7400BP from Daikin Industries Ltd., Osaka, Japan.

In another embodiment of the present disclosure, the fluoropolymer is not a fluoro-thermoplastic elastomer.

In one embodiment, the high molecular weight fluoropolymer has a number average molecular weight (Mn) of at least 20; 25; 40; 50; 100; 300; 500; 750; 1000; or even 1500 kilograms/mole measured by techniques known in the art.

Additional Components

In addition to the low molecular weight fluorinated (meth)acrylate polymer and the high molecular weight polymer, the pressure sensitive adhesive composition may comprise additional components to impact the performance and/or properties of the PSA composition. Such additives include plasticizers, additional tackifiers, crosslinking agents, UV stabilizers, antistatic agents, colorants, antioxidants, fungicides, bactericides, organic and/or inorganic filler particles, and the like.

Plasticizers can be used to adjust the glass transition temperature and/or to adjust the modulus of the pressure sensitive adhesive composition to improve the adhesion of the composition to a substrate.

Exemplary plasticizers include: hydrocarbon oils (e.g., those that are aromatic, paraffinic, or naphthenic), hydrocarbon resins, polyterpenes, rosin esters, phthalates (e.g., terephthalate), phosphates esters, phosphates (e.g., tris(2-butoxyethyl) phosphate), dibasic acid esters, fatty acid esters, polyethers (e.g., alkyl phenyl ether), epoxy resins, sebacate, adipate, citrate, trimellitate, dibenzoate, or combinations thereof.

In one embodiment, the plasticizer is a fluorinated compound, having a number average molecular weight greater than 0.5 kilograms/mol; and less than 20, 15, or even 10 kilograms/mole and a Tg less than about −15, −20, or even −25° C. Such fluorinated plasticizers may include: an ultralow viscosity and/or liquid fluoroelastomer available under the trade designation “3M DYNEON FC 2210X” available from 3M Co., St. Paul, Minn.; “DAI-EL G101” available from Daikin Industries, Ltd., Osaka, Japan; and “VITON LM” which used to be commercially available from The Chemours Co., Wilmington, Del. Additional fluorinated plasticizes include fluorinated oils such as those available under the trade designation “KRYTOX” commercially available from The Chemours Company, Wilmington, Del.; “DEMNUM” commercially available from Daikin Industries Ltd., Osaka, Japan; and “FOMBLIN” commercially available from Solvay S. A. Brussels, Belgium.

The plasticizers may be present in the composition in any suitable amount, such as for example, amounts up to about 50, 70, 100, 200, 300, 350, or even 400 parts by weight, based on 100 parts by weight of the high molecular weight polymer.

In additional to the low molecular weight fluorinated (meth)acrylate polymer described herein for use as a tackifier in a pressure sensitive adhesive composition, additional non-fluorinated tackifiers may be used.

Exemplary non-fluorinated tackifiers include: rosins and their derivatives (e.g., rosin esters); polyterpenes and aromatic-modified polyterpene resins; coumarone-indene resins; hydrocarbon resins, for example, alpha pinene-based resins, beta pinene-based resins, limonene-based resins, aliphatic hydrocarbon-based resins, aromatic-modified hydrocarbon-based resins; or combinations thereof. Non-hydrogenated tackifiers resins are typically more colorful and less durable (i.e., weatherable). Hydrogenated (either partially or completely) tackifiers may also be used. Examples of hydrogenated tackifiers include, for example: hydrogenated rosin esters, hydrogenated acids, hydrogenated aromatic hydrocarbon resins, hydrogenated aromatic-modified hydrocarbon-based resins, hydrogenated aliphatic hydrocarbon-based resins, or combinations thereof. Examples of additional synthetic tackifiers include: phenolic resins, terpene phenolic resins, poly-t-butyl styrene, acrylic resins, or combinations thereof. In one embodiment, the non-fluorinated tackifier may be present in the pressure sensitive composition in an amount of greater than about 10, 20, or even 40 parts by weight and no more than 100 parts by weight based on 100 parts by weight of the high molecular weight polymer.

Other optional additives include, for example, stabilizers (e.g., anti-oxidants or UV-stabilizers), pigments, dyes, or combinations thereof. Use of such additives is well known to those of ordinary skill in the art. The additives may be present in an amount from 0.5% by weight to 5% by weight based upon the weight of the total pressure sensitive adhesive. Certain additives may be of lower weight percent, e.g., a pigment may be added at less than 0.05% or even less than 0.005% by weight based on 100 parts of the high molecular weight polymer.

Preferred anti-oxidants include phenols, phosphites, thioesters, amines, polymeric hindered phenols, copolymers of 4-ethyl phenols, reaction product of dicyclopentadiene and butylene, or combinations thereof. Additional examples include phenyl-alpha-naphthylamine, phenyl-beta-naphthylamine, phenyl-beta-naphthylene, 2,2′-methylene bis (4-methyl-6-tertiary butyl phenol), phenolic-based anti-oxidants sold under the trade designation “CIBA IRGANOX 1010” by from Ciba Specialty Chemicals Corp., Tarrytown, N.Y., or combinations thereof.

UV-stabilizers such as UV-absorbers are chemical compounds that can intervene in the physical and chemical processes of photoinduced degradation. Exemplary UV-absorbers include: benzotriazole compound, 5-trifluoromethyl-2-(2-hydroxy-3-alpha-cumyl-5-tert-octylphenyl)-2H-benzotriazole, or combinations thereof. Other exemplary benzotriazoles include: 2-(2-hydroxy-3,5-di-alpha-cumylphehyl)-2H-benzotriazole, 5-chloro-2-(2-hydroxy-3-tert-butyl-5-methylphenyl)-2H-benzotiazole, 5-chloro-2-(2-hydroxy-3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, 2-(3-tert-butyl-2-hydroxy-5-methylphenyl)-5-chloro-2H-benzotriazole, or combinations thereof. Additional exemplary UV-absorbers include 2(−4,6-diphenyl-1-3,5-triazin-2-yl)-5-hexcyloxy-phenol, and those available from Ciba Specialty Chemicals Corp. sold under the trade designations “CIBA TINUVIN 1577” and “CIBA TINUVIN 900”. In addition, UV-absorber(s) can be used in combination with hindered amine light stabilizer(s) (HALS) and/or anti-oxidants. Exemplary HALSs include those available from Ciba Specialty Chemicals Corp. Basel, Switzerland sold under the trade designations “CIBA CHIMASSORB 944” and “CIBA TINUVIN 123”.

In one embodiment, to improve the bond strength or other properties of the adhesive, the polymer (for example, the low molecular weight fluorinated (meth)acrylate polymer and/or the high molecular weight polymer) may comprise pendent functional groups, such as —OH and/or —COOH groups or salts thereof, which are present along the polymer chain or at the ends of the polymer chains. Such groups may assist in improving the bond strength of the adhesive. In one embodiment, these pendent functional groups comprise less than 10, 5, 3, or even 2 mol % and more than 0.1, 0.5, or even 1 mol % based on the respective polymer.

Pressure Sensitive Adhesive Composition

In one embodiment, the pressure sensitive adhesive composition would comprise at least 10, 25 or even 50 parts; and no more than 400, 300, 200 or even 100 parts of the low molecular weight fluorinated (meth)acrylate polymer per 100 parts of the high molecular weight polymer.

The pressure sensitive adhesive composition comprising the low molecular weight fluorinated (meth)acrylate polymer and the high molecular weight polymer, along with optional additives may be formulated in a solvent or solventless process.

The pressure sensitive adhesive composition according to the invention may be obtained using techniques commonly known to those skilled in the art of formulating pressure sensitive adhesive formulations.

In one embodiment, the pressure sensitive adhesive composition is hot melt processable.

In one embodiment, the pressure sensitive adhesive composition is crosslinked.

The crosslinked pressure sensitive adhesives and the uncrosslinked or crosslinkable pressure sensitive adhesive compositions, in particular the hot melt and solution processable adhesives and precursors thereof, may advantageously be used to prepare a wide range of adhesive tapes and articles. Many of these tapes and articles contain backings or other substrates to support the layer of adhesive. Double-sided tapes are adhesive tapes that have adhesive on opposite sides of a backing layer. The adhesives on the two sides may be the same or different. The backing layer may be a film, a non-woven web, paper, or a foam. Other adhesive tapes and articles do not contain a backing or substrate layer and therefore are free standing adhesive layers. Transfer adhesive tapes are an example of such an adhesive article. Transfer adhesives tapes, also called transfer tapes, have an adhesive layer delivered on one or more release liners. The adhesive layer has no backing within it so once delivered to the target substrate and the liner is removed, there is only adhesive. Some transfer tapes are multi-layer transfer tapes with at least two adhesive layers that may be the same or different.

Transfer tapes are widely used in the printing and paper making industries for making flying splices, as well as being used for a variety of bonding, mounting, and matting applications both by industry and by consumers.

In one embodiment, the pressure sensitive adhesive compositions may be easily coated upon a carrier film by conventional coating techniques to produce adhesive coated sheet materials or coated and cured via ultraviolet or e-beam radiation. The coating thickness will vary depending upon various factors such as, for example, the particular application or the coating formulation. Coating thicknesses of 10, 20, 25, 30, 40, 50, 60, 75, 100, 125, 150, 200, 250 μm, or 300 μm are contemplated.

The carrier film may be a flexible or inflexible backing material, or a release liner. Exemplary materials useful as the carrier film for the adhesive articles of the disclosure include, but are not limited to, polyolefins such as polyethylene, polypropylene (including isotactic polypropylene and high impact polypropylene), polystyrene, polyester, including poly(ethylene terephthalate), polyvinyl chloride, poly(butylene terephthalate), poly(caprolactam), polyvinyl alcohol, polyurethane, poly(vinylidene fluoride), cellulose and cellulose derivatives, such as cellulose acetate and cellophane, and wovens and nonwovens. Commercially available carrier film include kraft paper (available from Monadnock Paper, Inc.); spun-bond poly(ethylene) and poly(propylene), such as those available under the trade designations “TYVEK” and “TYPAR” (available from The Chemours Co.); and porous films obtained from poly(ethylene) and poly(propylene), such as those available under the trade designations “TESLIN” (available from PPG Industries, Inc.), and “CELLGUARD” (available from Hoechst-Celanese). The carrier film delivers the pressure sensitive adhesive of the present disclosure to the desired substrate. The carrier film may comprise on the surface opposite the pressure sensitive adhesive, a pigment, indicia, text, design, etc., which is then fixedly attached to the surface of the substrate or the carrier film may be free of such pigments and/or markings.

In one embodiment, a layer of the pressure sensitive adhesive is fixedly attached to a backing layer. The backing layer may be any material conventionally utilized as a tape backing. In one embodiment, a chemical primer layer is disposed between the pressure sensitive adhesive and the backing layer to improve the adhesion of the pressure sensitive adhesive to the backing layer. Such primer layers are known in the art. In one embodiment, the backing material is corona treated, plasma treated, and/or nanostructured to improve the adhesion of the PSA to the backing material. Such nanostructure materials can be made as described, for example, in WO 2014/047782 (David, et. al).

The thickness of the pressure sensitive adhesive layer is typically at least 10, 15, 20, or 25 microns (1 mil) ranging up to 500 microns (20 mils) thickness. In some embodiments, the thickness of the pressure sensitive adhesive layer is no greater than 400, 300, 200, or 100 microns. The pressure sensitive adhesive can be coated in single or multiple layers.

In one embodiment, the pressure sensitive adhesive composition has a viscoelastic window as defined by E. P. Chang, J. Adhesion, vol. 34, pp. 189-200 (1991) such that the dynamic mechanical properties of the pressure sensitive adhesive composition as measured by well-known techniques fall within the following ranges measured at 25° C.:

G′ measured at an angular frequency of 0.01 rad/s is greater than 1×10³ Pa
G′ measured at an angular frequency of 100 rad/s is less than 1×10⁶ Pa
G″ measured at an angular frequency of 0.01 rad/s is greater than 1×10³ Pa
G″ measured at an angular frequency of 100 rad/s is less than 1×10⁶ Pa.

In one embodiment, the adhesive composition further meets the Dahlquist criterion for tack in that the G′ measured at 1 rad/s is less than 3×10⁵ Pa.

In some embodiments, the pressure sensitive adhesive composition has a storage modulus G′ of less than 1×10⁶ Pa measured at 1 rad/s.

In one embodiment, the pressure sensitive adhesives of the present disclosure have the ability to adhere to a variety of surfaces under extreme conditions. The articles of the present disclosure can be subjected to harsh weather conditions such as temperature extremes, humidity, atmospheric pollutants, road salt, and infrared, visible, and ultraviolet light.

In one embodiment, the pressure sensitive adhesive composition of the present disclosure have a 180° peel to stainless steel of at least 10, 25, 20, 25, 30, 35, 40, 45, 50, 55, 60, 80, 100, 125, or even 150 N/dm at a peel rate of 300 mm/minute peel rate after a 24 hour dwell time at ambient conditions.

In one embodiment, the pressure sensitive adhesive composition of the present disclosure have a 180° peel to polyethylene of at least 10, 15, 20, 25, 30, 35, 40, 45, 50, 55, 60, 80, 100, 125, or even 150 N/dm at a peel rate of 300 mm/minute peel rate after a 24 hour dwell time at ambient conditions.

In one embodiment, the pressure sensitive adhesive composition of the present disclosure have a 180° peel on a fluorinated surface of at least 5, 10, 15, 20, 25, 30, 35, 40, 45, 50, 55, 60, 80, 100, 125, or even 150 N/dm at a peel rate of 300 mm/minute peel rate after a 24 hour dwell time at ambient conditions. Such fluorinated surfaces include: FEP (fluorinated ethylene-propylene) copolymers containing TFE and 5-25 wt % HFP, such as for example “3M DYNEON FEP 6307Z” or PTFE (polytetrafluoroethylene).

In some embodiments, the pressure sensitive adhesive may exhibit the same or higher level of adhesion to stainless steel or a fluorinated surface after exposure to elevated temperatures and humidity, such as after a 72 hour dwell time at 65° C. and 80% relative humidity. In some embodiments, the increase in adhesion is no greater than 300%, 250%, 200%, 150%, 100%, 90%, 80%, or 70% (as determine by subtracting the 24 hr room temperature value from the aged peel value, dividing by the 24 hr room temperature value and multiplying by 100%).

The pressure sensitive adhesives of the present disclosure surprisingly show good adhesion to a variety of low surface energy substrates and under a variety of complex bonding situations.

In addition, the pressure sensitive adhesive may be applied to surfaces with different topographies such as smooth and/or rough surfaces, which make bonding much more complex.

In some applications, organic fluids, such as oil or fuel may contact the substrate and/or the pressure sensitive adhesive and decrease the performance of the pressure sensitive adhesive. In one embodiment, the pressure sensitive adhesive of the present disclosure provides resistance to solvent, oil, and benzene/diesel.

In one embodiment, the pressure sensitive adhesive composition of the present disclosure has a swell ratio of less than 1.2 or even a swell ratio of no more than 1.01 in oleic acid, and/or in a 70% isopropyl alcohol aqueous solution.

The pressure sensitive adhesive composition described herein may also be disposed on a transparent film for use as a removable or permanent surface protection film. In some embodiments, the pressure sensitive adhesive and transparent film have a transmission of visible light of at least 90 percent.

The pressure sensitive adhesives described herein are suitable for use in the areas of electronics, appliances, automotive, and general industrial products. In some embodiments, the pressure sensitive adhesive can be utilized in (e.g. illuminated) displays that can be incorporated into household appliances, automobiles, computers (e.g. tablets), and various hand-held devices (e.g. phones).

The presently disclosed adhesive composition can be laminated to solid substrates at ambient temperature (25° C.) and provide good high temperature/humidity stability and chemical resistance. The superior oil (e.g. oleic acid) and alcohol resistance of the presently disclosed adhesive composition makes the adhesive composition attractive for various applications including automotive, aerospace, electronics and appliance markets where maintaining adhesive bond strength under high temperature/humidity and chemical environment are of importance.

In some embodiments, the pressure sensitive adhesive described herein are suitable for bonding internal components or external components of illuminated display devices such as liquid crystal displays (“LCDs”) and light emitting diode (“LEDs”) displays such as cell phones (including Smart phones), wearable (e.g. wrist) devices, car navigation systems, global positioning systems, depth finders, computer monitors, notebook and tablet computer displays.

Exemplary embodiments of the present disclosure include, for example:

### Embodiment 1

Use of a low molecular weight fluorinated (meth)acrylate polymer as a tackifier in a pressure sensitive adhesive composition, wherein the low molecular weight fluorinated (meth)acrylate polymer comprises a plurality of pendent sulfonylamide groups.

### Embodiment 2

The use according to embodiment 1, wherein the pressure sensitive adhesive composition comprises a high molecular weight polymer, having a at least one Tg, which is at most 0° C. and a number average molecular weight of at least 20 kilograms/mole.

### Embodiment 3

The use according to embodiment 2, wherein the high molecular weight polymer is derived from a (meth)acrylate monomer.

### Embodiment 4

The use according to embodiment 3, wherein the (meth)acrylate monomer comprises at least one of: iso-octyl acrylate, 2-octyl acrylate, 2-ethylhexyl acrylate, 2-propylheptyl acrylate, octadecyl acrylate, stearyl acrylate, butyl acrylate, 2-methyl butylacrylate, C₁₈ acrylate derived from Guerbet alcohols, 2-hetpyl undecanyl acrylate, and combinations thereof.

### Embodiment 5

The use according to embodiment 2, wherein the high molecular weight polymer is a fluoropolymer.

### Embodiment 6

The use according to embodiment 5, wherein at least 10% of all of the C—H and C—F bonds in the high molecular weight fluorinated polymer are C—F bonds.

### Embodiment 7

The use according to any one of embodiments 2-6, wherein the adhesive composition comprises 10 to 400 parts of the low molecular weight fluorinated (meth)acrylate polymer per 100 parts of the high molecular weight polymer.

### Embodiment 8

The use according to any one of the previous embodiments, wherein the low molecular weight fluorinated (meth)acrylate polymer has a glass transition temperature of −15° C. to 40° C.

### Embodiment 9

The use according to any one of the previous embodiments, wherein the low molecular weight fluorinated (meth)acrylate polymer has a number average molecular weight of 0.5 to 10 kilograms/mole.

### Embodiment 10

The use according to any one of the previous embodiments, wherein the low molecular weight fluorinated (meth)acrylate polymer comprises at least four and no more than 50 monomeric units.

### Embodiment 11

The use according to any one of the previous embodiments, wherein at least 10% of all of the C—H and C—F bonds in the low molecular weight fluorinated (meth)acrylate polymer are C—F bonds.

### Embodiment 12

The use according to any one of the previous embodiments, wherein the low molecular weight fluorinated (meth)acrylate polymer comprises a segment according to formula I:

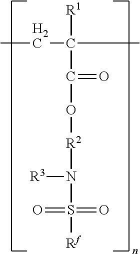

wherein R¹ is H or CH₃; R² is a linking group; R³ is H or an alkyl group; R_{f} comprises a perfluorinated group; and n is at least 2.

### Embodiment 13

The use according to embodiment 12, wherein R² comprises at least one of an alkylene, a carbamate group, an ester group, a urea group, and combinations thereof.

### Embodiment 14

The use according to any one of embodiments 12-13, wherein the perfluorinated group comprises 1 to 10 carbon atoms.

### Embodiment 15

The use according to any one of the previous embodiments, wherein the low molecular weight fluorinated (meth)acrylate polymer is derived from a first monomer comprising a pendent sulfonylamide group and a second monomer, wherein the second monomer is selected from a (meth)acrylate.

### Embodiment 16

The use according to embodiment 15, wherein the low molecular weight fluorinated (meth)acrylate polymer is derived from at least 50% by moles of the first monomer.

### Embodiment 17

The use according to any one of the previous embodiments, wherein the high molecular weight polymer comprises a functional pendent group.

### Embodiment 18

The use according to embodiment 17, wherein the functional pendent group is —OH, —COOH, and combinations and salts thereof.

### Embodiment 19

The use according to any one of the previous embodiments, wherein the low molecular weight fluorinated (meth)acrylate polymer comprises a plurality of pendent sulfonylamide groups further comprises a pendent group comprising at least one of —OH, —COOH, combinations and salts thereof.

### Embodiment 20

The use according to any one of the previous embodiments, wherein the pressure sensitive adhesive composition is crosslinked.

### Embodiment 21

The use according to any one of the previous embodiments, wherein the pressure sensitive adhesive composition further comprises a crosslinking agent.

### Embodiment 22

The use according to any one of the previous embodiments, wherein the pressure sensitive adhesive composition further comprises a plasticizer.

### Embodiment 23

The use according to any one of the previous embodiments, wherein the pressure sensitive adhesive composition has a 180° peel to stainless steel of at least 10 N/dm at a peel rate of 300 mm/min after a 24 hour dwell time at 25° C. and 50±5% relative humidity.

### Embodiment 24

The use according to any one of the previous embodiments, wherein the pressure sensitive adhesive composition has a swell ratio of less than 1.2 in oleic acid and less than 1.2 in 70% isopropyl alcohol aqueous solution after 24 hours at 65° C.

### Embodiment 25

The use according to any one of the previous embodiments, wherein the pressure sensitive adhesive composition has a chemical resistance rating of at least 3 for oleic acid and/or a 70% isopropyl alcohol aqueous solution after 8 hours at 70° C.

### Embodiment 26

A pressure sensitive adhesive composition comprising:

a high molecular weight polymer; and

10 to 400 parts of a low molecular weight fluorinated (meth)acrylate polymer per 100 parts of the high molecular weight polymer, wherein the low molecular weight fluorinated (meth)acrylate polymer comprises a plurality of pendent sulfonylamide groups to form a pressure sensitive adhesive.

### Embodiment 27

A pressure sensitive adhesive composition according to embodiment 26 having dynamic mechanical properties measured at 25° C. such that

G′ measured at an angular frequency of 0.01 rad/s is greater than 1×10³ Pa

G′ measured at an angular frequency of 100 rad/s is less than 1×10⁶ Pa

G″ measured at an angular frequency of 0.01 rad/s is greater than 1×10³ Pa

G″ measured at an angular frequency of 100 rad/s is less than 1×10⁶ Pa.

### Embodiment 28

A pressure sensitive adhesive composition according to any one of embodiments 26-27 having a value of G′ measured at 25° C. and an angular frequency of 1 rad/s of less than 3×10⁵ Pa.

### Embodiment 29

A multilayered article comprising the pressure sensitive adhesive composition according to any one of embodiments 26-28 disposed a backing.

### Embodiment 30

A multilayered article comprising the pressure sensitive adhesive composition according to any one of embodiments 26-29 disposed a liner.

### Embodiment 31

A method of making a pressure sensitive adhesive, the method comprising: combining a low molecular weight fluorinated (meth)acrylate polymer having a plurality of pendent sulfonylamide groups with a high molecular weight polymer to form a pressure sensitive adhesive.

### EXAMPLES

Unless otherwise noted, all parts, percentages, ratios, etc. in the examples and the rest of the specification are by weight (based on solids), and all reagents used in the examples were obtained, or are available, from general chemical suppliers such as, for example, Sigma-Aldrich Company, Saint Louis, Mo.

These abbreviations are used in the following examples cm=centimeter; dm=decimeter; dl=deciliter; g=grams; min=minutes; mJ=milliJoules; hr=hour; ° C.=degrees Celsius; and pph=parts per hundred.

Test Methods

Molecular Weight Distribution

The molecular weight distribution of the low molecular weight fluorinated (meth)acrylate compounds was characterized using conventional gel permeation chromatography (GPC). The GPC instrumentation, which was obtained from Waters Corporation (Milford, Mass., USA), included a high pressure liquid chromatography pump (Model 600), an auto-sampler (Model WISP717), and a refractive index detector (Model 2414).

The chromatograph was equipped with three 10 micron PLgel MIXED-B columns 300 mm×7.5 mm, available from Agilent Technologies. (Santa Clara, Calif., USA).

Each sample of polymeric solution was treated with an ethereal diazomethane solution. The reaction was done at room temperature for at least 30 minutes. The sample was dried under a gentle flow of nitrogen until dryness. The residue was dissolved in tetrahydrofuran at a concentration of 0.1 percent (weight/volume). The solution was filtered through a 0.45 micron polytetrafluoroethylene filter, available from Machery-Nagel (Düren-Germany).

The resulting sample was injected into the GPC instrument and eluted with tetrahydrofuran at a rate of 1 milliliter per minute through the columns that were maintained at 40° C. The system was calibrated with polystyrene standards using 3rd order fit analysis to establish a calibration curve.

The number average molecular weight (Mn) and the weight average molecular weight (Mw) were calculated for each sample against the standard calibration curve. Mn and Mw are recorded in kilograms/mole (kg/mole).

Glass Transition Temperature

The glass transition temperature (Tg) was determined following ASTM D 7426-08 (Reapproved 2013), unless otherwise noted, by differential scanning calorimetry (DSC Q200 available from TA Instruments, New Castle, Del.) with liquid nitrogen as the coolant. The samples were equilibrated at about −80° C. and held for 10 min. A DSC scan was obtained from −80° C. to 200° C. (or −80° C. to 150° C.) and a scan rate of 10° C./min was used. The purge gas was helium (99.999% pure, dried over a moisture filter) flowing at 50 mL/min. The midpoint temperature was used to report the Tg.

Dynamic Mechanical Analysis (DMA)

Dynamic mechanical testing was conducted using standard methods using parallel plate geometry in an oscillatory shear mode with stress and strain oscillating sinusoidally at a controlled frequency, expressed herein as an angular frequency, radians/sec, where one cycle of oscillation is 2π radians. As described in standard viscoelasticity references (e.g. “Viscoelastic Properties of Polymers,” J. D. Ferry, 3^{rd} edition, John Wiley and Sons, 1980), the material property parameters, dynamic modulus (G*), and phase angle (δ) were determined. G* is the ratio of peak-to-peak stress amplitude to peak-to-peak strain amplitude and the phase angle is the shift between the phase of the stress wave and that of the strain wave, expressed either in degrees or radians. One full cycle of oscillation is 360 degrees or 2π radians. From these parameters, the parameters G′, G″ and tan δ are derived as follows:

G′=G*cos δ

G″=G*sin δ

tan δ=tangent of δ which is also equal to G″/G′

A sample of the adhesive composition was prepared by compression molding or by lamination of coated layers to a thickness of approximately 1 mm. From this sample, an 8 mm diameter disk was cut using a die. That disk shaped sample was mounted between two 8 mm diameter parallel plate fixtures of a TA Instruments Discovery Hybrid Rheometer Model DHR-3 or an ARES G2 rheometer also made by TA Instruments.

Temperature Ramp Test to Determine DMA Tg:

These tests were conducted using the DHR-3 rheometer. Using automatic control of the axial force of the fixtures on the sample, the material was subjected to cyclic shear oscillation while the instrument monitored the oscillating shear stress and shear strain. A constant oscillation angular frequency of 1 rad/s (cyclic frequency of ½π Hz) was applied with a shear strain of 5% while the sample temperature was ramped from 25° C. to −65° C. at a rate of 3° C./min. When the shear stress exceeded 50 kPa, the system switched to a controlled shear stress mode at a constant shear stress of 50 kPa. When the G* exceeded 5×10⁸ Pa or when the temperature reached −65° C. (whichever came first), the temperature was returned to 20° C. while maintaining axial force control. The temperature was then ramped from 20° C. to 150° C. or until the G* value fell below 10³ Pa using a constant strain of 5^{%}.

The DMA glass transition temperature (DMA Tg) was taken as the temperature at which the value of the tangent of the phase angle, δ, (tan δ) reached a maximum during the phase where the shear storage modulus rises from about 10⁵ Pa to above 10⁸ Pa as the temperature drops.

Frequency Sweep Test for Viscoelastic Window and Dahlquist Criterion Properties:

These tests were conducted using the ARES G2 rheometer. The 8 mm disk shaped sample was mounted between 8 mm diameter fixtures, first applying an axial force of about 100 g to achieve good bonding between the fixture and the sample and then the axial force was controlled near zero g+/−20 g. A frequency sweep was conducted with the sample controlled at 25° C. and a constant shear strain of 5% to measure the properties at 0.01, 1, and 100 rad/s angular frequency.

Adhesive Testing

Unless otherwise indicated, prior to testing all adhesive samples were conditioned in a climate room set at ambient conditions (23° C.+/−2° C. and 50%+/−5% relative humidity) during 12 hours.

Substrates Used:

Stainless steel panels: The stainless steel panels (51 mm wide by 127 mm long by 1.2 mm thick having a bright annealed finish (in accordance with Specification ASTM A666-10, Type 304) were obtained from ChemInstruments, Incorporated, Fairfield, Ohio). Prior to use stainless steel panels were cleaned by wiping the panels with a lint free tissue first with a pass of methyl ethyl ketone (MEK), followed by a wipe with n-heptane and finally another pass with methyl ethyl ketone (MEK). Wiping of the panels per pass of solvent was always done until dryness.

Tetrafluoroethene-hexafluoropropene: An FEP (a co-polymer derived from tetrafluoroethene and hexafluoropropene) film was made from FEP granules being available under the trade designation “3M DYNEON FLUOROPLASTIC FEP 6307” from 3M Co. The FEP films were attached to clean stainless steel plates with an adhesive film. Prior to use, the exposed FEP surface of the multilayered construction was cleaned with a 90/10 mixture of isopropyl alcohol (IPA) and water.

Polyethylene: The polyethylene (PE) test panels were PE covered aluminum panels. PE film having a thickness of 330 μm was prepared from polyethylene pellets, available under trade designation “VORIDIAN POLYETHYLENE 1550P” from Eastman Chemical Co. (Kingsport, Tenn., USA). Test panels were prepared by fixing the PE film to the aluminum plate with adhesive tape. The rougher surface of the PE was affixed to the aluminum plate with the smoother surface outwardly facing for testing. The PE covered aluminum panels were not cleaned prior to use.

PTFE test panels (51 mm wide by 127 mm long by 2 mm thick) were obtained from Rocholl Gmbh-Aglasterhausen Germany. They were cleaned prior to use with 90/10 isopropanol/water.

180° Peel Adhesion

TM-1 180° Peel Adhesion

The peel adhesion tests were performed in accordance with AFERA 5001 (version 2004) test method.

Adhesive test samples were prepared by slitting adhesive strips of 25.4 mm×300 mm in dimension using a specimen cutter holding two single-edged razor blades in parallel planes of the adhesive. The strip was placed without pressure onto a (cleaned) test substrate, after which the strip was fixed onto the substrate using a 2 kg hand-held rubber-covered roller at a rate of 10+/−0.5 mm/s with 2 passes in each direction. After a dwell time, as indicated in the examples, in the climate room, a 180° peel test was performed using a FP-2255 Peel Tester (manufactured by Thwing-Albert Instrument Company), with data collected and averaged over 10 seconds. The adhesive strip was pulled at a speed of 300 mm/min. Three measurements were made per example and the average recorded in N/dm. The test results were reported as “180° Peel TM-1”.

TM-2: 180° Peel Adhesion

Adhesive test samples were prepared by slitting adhesive strips of 12.7 mm×127 mm in dimension. Two replicates were prepared for each sample. The exposed adhesive surface of the test strips were adhered along the length of a test substrate. The adhesive strip was then rolled-over 2 times using a 2.0 kg rubber roller. The peel adhesion strength was evaluated using an Imass model SP2000 peel tester (IMASS Corp., Accord, MA), with the test specimen held horizontally on the plate and the adhesive being peeled at an angle of 180° and at a speed of 300 mm/min. The average of two test specimens was reported in N/dm. The test results were reported as “180° Peel TM-2”

TM-3: Peel Adhesion Strength (Aging)

Test samples with adhesive strips of 5 mm by 127 mm were prepared as described above in TM-2. Before testing, the samples were dwelled for 24 hours in a climate room set at ambient conditions followed by 72 hours dwell in an oven set at 65° C. and having 80% RH. The samples were then returned to the climate room for 24 hours prior to adhesion testing. The peel adhesion strength was evaluated using an Instron equipped with 1000 N load cell, using a crosshead speed of 300 mm/min, at an angle of 180° with the test specimen held in the bottom clamp and the tail in the top clamp. The average of two test specimens was reported in N/decimeter (N/dm). The test results were reported as “Aged Peel TM-3”.

Static Shear Strength on Stainless Steel (SS)

The static shear test method determines the ability of pressure-sensitive adhesive tapes to remain adhered under constant load applied parallel to the surface of the tape and substrate. The test was performed according to AFERA 5012 Test Method “Self Adhesive Tapes-Measurement of Static Shear Adhesion EN 1943 2002” (version 2004).

Static shear strength was measured on cleaned stainless steel panels having a dimension of 50 mm by 125 mm (and a minimum thickness of 1.1 mm).

A 1 inch (25.4 mm) wide strip of adhesive was cut from the adhesive tape by using a specimen cutter holding two single-edge razor blades in parallel planes, the blades spaced 1 inch (25.4 mm) apart. The adhesive strip was then placed onto a clean stainless steel panel covering a 1 inch×1 inch (25.4 mm×25.4 mm) area of the stainless steel panel. The adhesive strip was then rolled-over twice in each direction using a hand-held rubber-covered 2 kg hand-roller at an approximate rate of 10 mm+/−0.4 mm/s. A 1000 g (1 kg) weight was used as the static load. The test samples were placed on an automated timing apparatus in an air conditioned room at ambient conditions (23° C.+/−2° C. and 50%+/−5% relative humidity). Alternatively, the samples were left in the air conditioned room for a time as indicated in the example (indicated as ‘dwell time’) before testing. The time when the load dropped was recorded (min). When the load did not fall down after 10000 min, the test was discontinued and the result identified as 10000+. The data reported are the averages of three measurements.

Chemical Resistance Test

Samples were prepared by slitting test strips 0.5 inch×0.5 inch (12.7 mm×12.7 mm) from each of the adhesive transfer tape samples. Then, the release liner on one surface was removed and the test strips were attached (stuck) to the bottom of a glass petri dish. The release liner on the second, exposed surface of the test strips were removed and the petri dish containing the attached sample test strips were set aside to dwell at room temperature (about 23° C.) for 15 minutes. The test strips were then submerged in either (a) oleic acid, or (b) a mixture of isopropyl alcohol (IPA) and water at a weight ratio of 70:30 (IPA/H₂O) at 70° C. for 8 hrs. The resistance of the adhesive sample to oleic acid or IPA/H₂O mixture was rated using the following guidelines and reported.

Observation Chemical Resistance Rating:

1=Adhesive sample came off the petri dish or dissolved completely
3=Adhesive sample partially detached or dissolved along the edge
5=Adhesive sample did not detach or dissolve

Swell Test Ratio

A portion of the dry adhesive polymer (0.50-1.00 g dry) was separated from the release liner, weighed and then placed in a glass vial. Two samples in glass vials were prepared. A solvent of IPA/water 70/30 was added to one of the glass vials to completely immerse the sample. In the second glass vial, a solvent of oleic acid (10 g) was added to completely immerse the sample. Both vials were sealed and placed in an oven maintained at a temperature of 65° C. for a period of 24 hours. The glass vials were removed from the oven and allowed to cool to ambient temperature. The soaked samples were taken out from the vials, wiped reasonably dry with tissue paper, and weighed. The swelling ratio for each sample was determined by taking the dry weight of each sample over its weight after soaking in the solvent.

Liner Release Test Method

A 25 micrometer (1.0 mil) primed PET film was laminated to a layer of adhesive. A 25.4 mm strip was cut to form the test sample. The liner release value was a measure of the force required to pull the adhesive tape from the PET release liner at an angle of 180° at a rate of 2.3 m/min (90 inches)/minute. The IMass model SP2000 peel tester (IMASS Corp., Accord, MA) was used to record the peel adhesion value in grams/inch. The data is reported as an average of 2 measurements.

Materials Table

| Designation | Descriptor | Supplier |
|---|---|---|
| AA | Acrylic acid | Arkema, Colombes, |
| | | France |
| ABP | Acryloyl benzophenone | Prepared generally |
| | | according to U.S. Pat. |
| | | No. 4,737,559, example A |
| AEBP | para-acryloxyethoxybenzophenone | Prepared generally |
| | | according to U.S. Pat. |
| | | No. 4,737,559, example B |
| IBOMA | Isobornyl methacrylate | Sigma Aldrich |
| C4MA | N-methyl | Prepared generally |
| | perfluorobutylsulphonamidoethylmethacrylate | according to example |
| | | 2 in U.S. Patent No. |
| | | 6,664,354 |
| MEFBSE | N-Methylperfluorobutylsulphonamido ethyl alcohol | Prepared generally |
| | | according to example |
| | | 2 in U.S. Patent No. |
| | | 6,664,354 |
| MEFBSEIEM | 1/1 adduct of MEFBSE and IEM | Prepared generally |
| | | according to the |
| | | method listed below |
| IEM | Isocyanato ethyl methacrylate (KARENZ MOI) | Showa Denko, Tokyo, |
| | | Japan |
| DMAEMA | Dimethylaminoethyl methacrylate | Degussa AG, Essen, |
| | | Germany |
| Fluoropolymer | High molecular weight fluoropolymer made from | Can be prepared |
| 1 | VDF/HFP copolymer having a theoretical monomer | similar to Example 4 |
| | ratio of 61 wt % VDF/39 wt % HFP; Tg −23° C.; Mn 76 | of U.S. Pat. No. 6,693,152 |
| | kg/mole, Mw 132 kg/mole | |
| Fluoropolymer | Peroxide curable high molecular weight | Can be prepared |
| 2 | fluoroelastomer made from VDF/HFP/TFE and a cure | similar to Terpolymer |
| | site monomer, having 66% fluorine content and a | A in example 4 of |
| | theoretical monomer ratio of 60% VDF/31% HFP/9% | U.S. Pat. No. 7,138,470 |
| | TFE by weight; Tg −23° C. Mn 82.4 kg/mole, Mw 234 kg/mole. | |
| Fluoropolymer | Peroxide curable VDF/HFP/TFE fluoroelastomer | 3M Co., St. Paul, MN |
| 3 | terpolymer comprising cure sites available under the | |
| | trade designation “3M DYNEON | |
| | FLUOROELASTOMER FPO 3630” having a Tg −19° C., | |
| | a Mooney viscosity (ML 1 + 10@ 121° C.) of about | |
| | 37, and a Mn greater than 25 kg/mol. | |
| Fluoropolymer | VDF/HFP copolymer, available under the trade | 3M Co., St. Paul, MN |
| 4 | designation“3M DYNEON FLUOROELASTOMER | |
| | FC2178” having a Tg −22° C.; Mn 180 kg/mole, Mw | |
| | 480 kg/mole | |
| Fluoropolymer | VDF/HFP/PMVE fluoropolymer having a theoretical | Prepared generally |
| 5 | monomer ratio of 51.3 wt % VDF/11.3 wt % TFE/37.4 | according to Example |
| | wt % PMVE; Tg −32° C. Mn 82 kg/mole, Mw 139 | 1 of EP 2868674 |
| | kg/mole | |
| Fluoropolymer | A VDF/HFP fluoropolymer having a theoretical | Prepared generally |
| 6 | monomer ratio of 61 wt % VDF/39 wt % HFP; Tg −23° C., | according to Example |
| | Mn 80 kg/mole, Mw 223 kg/mole | 17 of U.S. Pat. No. 8,835,551 |
| IOA | Isooctyl acrylate | Sigma Aldrich |
| IOTG | Isooctylthioglycolate | Sigma Aldrich |
| NVC | N-Vinyl caprolactam | Sigma Aldrich |
| PETMP | Pentaerythritol tetrakis(3-mercaptopropionate) | Sigma Aldrich |
| DiPETMP | Dipentaerythritol hexa(3-mercaptoproprionate) | Bruno Bock |
| | | Chemische Fabrik |
| | | GmbH & Co. KG, |
| | | Marschacht, Germany |
| VAZO-88 | 1,1′-Azobis(cyclohexanecarbonitrile) | Sigma Aldrich |
| V-601 | Dimethyl 2,2′-azobis(2-methylpropionate) | Wako Pure Chemical |
| | | Industries, Ltd., |
| | | Osaka, Japan |
| Fluorinated | a liquid fluoroelastomer made from VDF/HFP | Can be prepared |
| plasticizer 1 | copolymer, having 66% fluorine content; viscosity | according to Example |
| | (105° C., spindle #27, 18.7 g, 5 rpm) approximately | 2 of U.S. Pat. No. 5,208,305 |
| | 20000 centipoise. Mn about 9 kg/mole. | |
| Fluorinated | VDF/HFP fluoropolymer, commercially available | The Chemours |
| plasticizer 2 | under the trade designation “VITON LM”. Brookfield | Company, |
| | viscosity of approximately 2000 centipoise (measured | Wilmington, DE |
| | at 100° C.) and a Mn of approximately 6 kilograms/mole | |
| MEHQ | Hydroquinone monomethylether | Sigma Aldrich |
| MMA | Methyl methacrylate | Brentag AG, Mulheim, |
| | | Germany |

Synthesis of MEFBSEIEM Monomer

A 500 ml 3 neck flask was charged with 100 g MEFBSE, 0,05 g Phenothiazine and 0.02 g MEHQ, and 175 g ethylacetate (EtAc). The mixture was stirred, warmed up until 65° C. and 15% of the EtAc was distilled off under mild vacuum with a Dean-Stark apparatus. Then the reaction mixture was put under nitrogen and lined out at 50° C. 0.2 g Dibutyltin laurate (Merck) was added. Then 43.4 g isocyanato ethyl methacrylate (IEM) was slowly added such that the temperature did not exceed 65° C. The reaction was followed with IR and stopped until the peak at 2272 cm⁻¹ disappeared. After reaction, the solvent was removed under vacuum which gave a white solid after cooling. The structure was confirmed with NMR.

Synthesis of Low Molecular Weight Fluorinated (Meth)Acrylate Polymers Comprising a Plurality of Pendent Sulfonamide Groups

The composition of the low molecular weight fluorinated (meth)acrylate polymers comprising a plurality of pendent sulfonamide groups used as tackifiers in the examples and comparative examples is provided in Table 1 (TACK1 to TACK 14).

The low molecular weight fluorinated (meth)acrylate polymers were prepared according to the general method as outlined below:

Glass bottles were charged with the monomers, n-butylacetate and chain transfer agent (CTA) in amounts as given in Table 1. The amount of solvent was calculated to have a solids content between 50 and 70% by weight. The bottles were sealed and rolled during 2 h to homogenize the mixture. Then 0.3% by weight of thermal initiator VAZO-88 (used as a 1% solution in n-butylacetate) was added. The bottles were degassed with a nitrogen flow of 1.0 liter/min during 3 minutes and then sealed. The reaction was run during 20 hours in a Launder-O-Meter set at 80° C. The composition of the fluorinated polymers was analyzed with GPC (Mn and Mw) and DSC (Tg), as described above. Also recorded is the % solids.

TABLE 1
Composition of fluorinated (meth)acrylate tackifiers (TACK)

| | | | | | Mn | Mw | |
|---|---|---|---|---|---|---|---|
| | | % by | CTA (PPH | | (kg/ | (kg/ | % |
| Tackifier | Monomers | weight | monomer) | Tg | mole) | mole) | solids |
| TACK 1 | C4MA | 100 | PETMP | 1.0 | 3.2 | 3.8 | 60 |
| | | | (20) | | | | |
| TACK 2 | C4MA/NVC | 99/1 | PETMP | 1.8 | 3.2 | 3.8 | 60 |
| | | | (20) | | | | |
| TACK 3 | C4MA/NVC | 97/3 | PETMP | 4.2 | 3.2 | 3.8 | 60 |
| | | | (20) | | | | |
| TACK 4 | C4MA/IBOMA/ | 75/24/1 | PETMP | −6.0 | 2.3 | 2.6 | 50 |
| | NVC | | (30) | | | | |
| TACK 5 | C4MA/NVC/ | 98.5/1/0.5 | PETMP | −13.0 | 2.4 | 2.8 | 50 |
| | AEBP | | (30) | | | | |
| TACK 6 | C4MA/NVC/ | 98/1/1 | PETMP | −8.0 | 2.1 | 2.7 | 60 |
| | AEBP | | (29) | | | | |
| TACK 7 | C4MA/ | 99/1 | PETMP | −6.1 | 3.4 | 4.0 | 60 |
| | DMAEMA | | (20) | | | | |
| TACK 8 | C4MA/ | 97/3 | PETMP | −13.1 | 3.1 | 3.7 | 60 |
| | DMAEMA | | (20) | | | | |
| TACK 9 | C4MA | 100 | PETMP | −8.0 | 2.2 | 2.8 | 60 |
| | | | (25) | | | | |
| TACK 10 | C4MA | 100 | IOTG | 2.0 | 1.9 | 3.0 | 60 |
| | | | (12) | | | | |
| TACK 11 | C4MA | 100 | DIPETMP | −6.0 | 2.7 | 3.5 | 60 |
| | | | (30) | | | | |
| TACK 12 | MEFBSEIEM/ | 99/1 | PETMP | 10.5 | 2.0 | 3.9 | 40 |
| | NVC | | (20) | | | | |
| TACK 13 | MEFBSEIEM/ | 50/50 | PETMP | 11.7 | 3.9 | 6.3 | 40 |
| | C4MA | | (16) | | | | |
| TACK 14 | MEFBSEIEM/ | 95/5 | PETMP | 15.6 | 3.5 | 5.0 | 40 |
| | MMA | | (16) | | | | |

Synthesis of High Molecular Weight Acrylate Polymer

An acrylate polymer “ACR-POL” IOA/AA/ABP 99.5/0.5/0.05 was produced via solution polymerization, in a solvent mixture of ethylacetate/heptane (in a ratio of 95/5) at 45% solids. IOA, AA and ABP were dissolved in the solvent mixture and allowed to polymerize. The polymerization was initiated by an azo initiator (V-601; 0.2% by weight, based on the monomers) and the mixture was polymerized under constant stirring for 20 hours at 60° C. The acrylate polymer was characterized by having in inherent viscosity (IV) of 0.89 as measured according to ASTM D 2857-2001 (IV test method) (measured on a 0.3 g/dl solution of the acrylate polymer in ethylacetate, at 25° C., using a Canon Fenske viscosimeter). The acrylate polymer solution was used as such.

XL-POL Synthesis

A UV crosslinking polymer (“XL-POL”) IOA/DMAEMA/AEBP 90/5/5 was produced via solution polymerization in ethylacetate, at 45% solids. Therefore, the monomers and AEBP were dissolved in ethylacetate. The polymerization was started by an azo initiator (V-601; 0.2% by weight, based on the monomers) and the polymerization took place under constant stirring for 20 hours at 60° C. The UV crosslinking polymer was characterized by having in inherent viscosity (IV) of 0.65 as measured according to ASTM D 2857-2001 (measured on a 0.3 g/dl solution of the acrylate polymer in ethylacetate at 25° C., using a Canon Fenske viscosimeter). The so formed crosslinking polymer solution was used as such.

Procedure for Making Adhesive Layers

Adhesive layers were prepared by solution processing. Therefore, solvent based mixtures were prepared having a composition as indicated in the examples. Adhesive layers were made by knife coating the solvent based mixture onto a double-sided siliconized paper liner (available from Mondi Akrosil, USA) having a thickness of 75 μm.

Unless otherwise indicated, the coatings were dried at room temperature during 6 minutes, followed by drying 105° C. during 7 min and 1 min at 120° C. The thickness of the dried adhesive layer is recorded in the examples. After drying, the adhesives were laminated on a 50 μm thick nanoetched PET backing. The liner side was always used for measuring adhesive properties (180° Peel and Static Shear, as indicated in the test methods above).

### EXAMPLES

### Examples 1 to 6 and Reference Example REF 1

A designed experiment was run on different combinations of TACK 5, Fluoropolymer 1 and Fluorinated Plasticizer 1. Therefore, 63% solids mixtures were prepared by blending Fluoropolymer 1 (solubilized in acetone) with TACK 5 (60% solids in butylacetate, preparation as outlined above) and Fluorinated plasticizer 1 (100% solids) in amounts as given in table 2. Adhesive layers were prepared from solution according to the general method as outlined above. The coating thickness of the dried adhesive layers was 50 □m+/−2 □m. Dynamic mechanical testing was performed according to the method as outlined above.

The composition of the samples and the rheology data are listed in tables 2 and 2a.

TABLE 2

| | | | | Storage | |
|---|---|---|---|---|---|
| | | | | modulus | |
| | Amount used (parts solid) | | | (G′) 25° C., | |
| | Fluoro- | TACK | Fluorinated | 1 rad/s | DMA T_{g} |
| Example | polymer 1 | 5 | plasticizer 1 | (10⁵ Pa) | ° C. |
| EX 1 | 100 | 60 | 0 | 2.44 | −5.5 |
| EX 2 | 100 | 33 | 133 | 1.08 | −17.5 |
| EX 3 | 100 | 16 | 16 | 3.37 | −14.0 |
| EX 4 | 100 | 150 | 150 | 0.47 | −9.1 |
| EX 5 | 100 | 50 | 50 | 1.59 | −10.9 |
| EX 6 | 100 | 133 | 33 | 0.67 | −6.1 |
| REF 1 | 100 | 0 | 0 | 4.71 | −19.9 |

TABLE 2a
Storage and loss modulus (in Pa)

| | G′ at 0.01 | G′ at 100 | G″ at 0.01 | G″ at 100 | G′ at 1 |
|---|---|---|---|---|---|
| Ex | rad/s | rad/s | rad/s | rad/s | rad/s |
| Ex 1 | 4.44 × 10⁴ | 7.29 × 10⁵ | 4.54 × 10⁴ | 6.93 × 10⁵ | 2.46 × 10⁵ |
| Ex 4 | 6.07 × 10³ | 4.15 × 10⁵ | 6.51 × 10³ | 4.91 × 10⁵ | 6.04 × 10⁴ |
| Ex 5 | 2.1 × 10⁴ | 3.41 × 10⁵ | 1.72 × 10⁴ | 2.58 × 10⁵ | 1.09 × 10⁵ |

The results indicate that Fluoropolymer 1, TACK 5, and Fluorinated Plasticizer 1 are miscible because only a single glass transition temperature was observed. It was further confirmed that TACK 5 acts as a tackifier since it raises the Tg of the mixture and reduces the G′ at 25° C. and 1 rad/s and that Fluorinated Plasticizer 1 acts as a plasticizer since it reduces the G′ at 25° C. with little change in the Tg.

The adhesive layers of examples 1 to 6 and Reference example REF 1 were tested for 180° peel adhesion, Static Shear, Chemical resistance, Swell Test Ratio and Liner Release according to the general methods outlined above. The results are recorded in Table 3.

TABLE 3

| | | | | RT static | Chemical | | | | |
|---|---|---|---|---|---|---|---|---|---|
| | | 180° peel | | shear SS | resistance test | | | | |
| | | adhesion | Aged | 1 kg/1 | rating | | Swell test ratio | | |
| | | SS | peel SS | inch by 1 | | IPA/ | | IPA/ | Liner |
| | Thickness | (TM-2) | (TM-3) | inch | Oleic | H₂O | Oleic | H₂O | release |
| Example | μm | N/dm | N/dm | (min) | acid | 70/30 | acid | 70/30 | g/inch |
| EX 1 | 50 | 40.3 | 97.9 | 3788 | 5 | 1 | 1.00 | 1.06 | 25.5 |
| EX 2 | 50 | 73.8 | 146.1 | 502 | 5 | 3 | 1.00 | 1.04 | 23.2 |
| EX 3 | 50 | 23.0 | ND | 10000+ | 5 | 3 | 1.00 | 1.04 | 27.9 |
| EX 4 | 50 | 136.4 | ND | 87 | 5 | 1 | 1.00 | 1.05 | 21.2 |
| EX 5 | 55 | 54.3 | 112.1 | 3184 | 5 | 3 | 1.00 | 1.04 | 21.4 |
| EX 6 | 50 | 17.1 | ND | 215 | 5 | 1 | 1.00 | 1.02 | 23.7 |
| REF 1 | 50 | 9.2 | ND | 10000+ | 5 | 3 | 1.00 | 1.03 | 31.3 |

Notes:
ND: not determined

### Examples 7 to 10

In examples 7 to 10, fluorinated PSA's comprising a low molecular weight (meth)acrylate polymer and high molecular weight fluorinated polymers having various molecular weight were evaluated. Therefore, 63% solids mixtures were prepared by blending 100 parts (solids) fluoropolymer as indicated in table 4 (solubilized in acetone) with 50 parts (solids) TACK 6 (from 60% solids mixture in n-butylacetate, preparation as outlined above) and 400 parts Fluorinated plasticizer 1 (100% solids). Adhesive layers were prepared according to the general procedure outlined above. Test specimen were prepared for the static shear and 180° peel, chemical resistance, swell test and liner release measurements as previously described. The coating thickness of the dried adhesive layers was 50 □m+/−2 □m. The test results are presented in Table 4.

TABLE 4

| | | | RT static | | | | | |
|---|---|---|---|---|---|---|---|---|
| | | 180° peel | shear SS | Chemical | | | | |
| | | adhesion | 1 kg/1 | resistance test | | | | |
| | | SS | inch by 1 | rating | | Swell test ratio | | Liner |
| | Fluoro- | (TM-1) | inch | Oleic | 70 IPA/ | Oleic | 70 IPA/ | release |
| Example | polymer | N/dm | (min) | acid | 30 H₂O | acid | 30 H₂O | g/inch |
| EX 7 | 1 | 120.0 | 976 | 5 | 3 | 1.00 | 1.04 | 29.5 |
| EX 8 | 2 | 122.1 | 1625 | 5 | 3 | 1.00 | 1.06 | 15.5 |
| EX 9 | 3 | 61.4 | 89 | 5 | 3 | 1.00 | 1.07 | 14.2 |
| EX 10 | 4 | 104.3 | 5333 | 5 | 3 | 1.00 | 1.10 | 12.1 |

### Examples 11 to 14

In examples 11 to 14, low molecular weight fluorinated (meth)acrylate polymers, prepared using different chain transfer agents were evaluated as tackifiers for fluorinated pressure sensitive adhesives. The adhesive formulations were prepared according to the general procedure outlined above using 63% solids mixtures containing 100 parts (solids) Fluoropolymer 1 (solubilized in acetone), 350 parts (100% solids) of fluorinated plasticizer 1 or fluorinated plasticizer 2 (as indicated in table 5) and 100 parts (solids) low molecular weight fluorinated (meth)acrylate polymers (TACK 9 to TACK 11) as listed in table 5. Adhesives layers were prepared from solution according to the procedure for making adhesive layers as given above.

Test specimen were prepared for the static shear and 180° peel adhesion (TM-1) as previously described. The test results are presented in Table 5.

TABLE 5

| | Low molecular | | | | |
|---|---|---|---|---|---|
| | weight | | | 180° peel TM-1 | RT shear on SS; 20 |
| | fluorinated | Fluorinated | Thickness | (1 day dwell) on | min dwell 1 kg/1 |
| EX | polymer | Plasticizer | (μm) | FEP 6307 (N/dm) | inch by 1 inch (min) |
| EX 11 | TACK 9 | 1 | 60 | 95.3 | 28 |
| EX 12 | TACK 9 | 2 | 62 | 50.8 | 10 |
| EX 13 | TACK 10 | 1 | 60 | 50.0 | 55 |
| EX 14 | TACK 11 | 1 | 60 | 54.7 | 40 |

### Examples 15 to 19

In examples 15 to 19 various low molecular weight fluorinated methacrylate polymers were evaluated as tackifier in fluorinated PSA formulations. Therefore, 63% solids mixtures were prepared according to the general procedure outlined above by blending 100 parts (solids) Fluoropolymer 1 (solubilized in acetone) with 350 parts Fluorinated plasticizer 1 and 100 parts (solids) of various low molecular weight fluorinated methacrylate polymers as listed in table 6. The adhesives were prepared from solution according to the procedure for making adhesive layers as given above. The coating thickness of all adhesives was 60 μm+−2 μm.

Test specimen were prepared for the static shear and 180° peel adhesion (TM-1) as previously described. The test results are presented in Table 6.

TABLE 6

| | | 180° peelTM-1 | RT shear on SS; 20 |
|---|---|---|---|
| | Fluorinated | (1 day dwell) on | MIN dwell 1 kg/1 |
| Example | tackifier | FEP 6307 (N/dm) | inch by 1 inch (min) |
| EX 15 | TACK 1 | 35.8 | 51 |
| EX 16 | TACK 2 | 108.3 | 44 |
| EX 17 | TACK 7 | 32.7 | 49 |
| EX 18 | TACK 3 | 100.0 | 53 |
| EX 19 | TACK 8 | 92.5 | 58 |

### Examples 20 to 22 and Reference Example REF-2

In examples 20 to 22 solvent based PSA formulations were prepared by blending the high molecular weight acrylate polymer (ACR POL) with TACK 4 and optional UV crosslinking polymer (XL POL) in amounts as listed in table 7. Reference example REF-2 was prepared in the same way, but without the addition of a low molecular weight fluorinated (meth)acrylate polymer. Adhesive layers were made by knife coating the solvent based mixture onto a white, double-sided siliconized paper liner (available from Mondi Akrosil, USA) having a thickness of 75 μm. The coatings were dried at room temperature during 6 minutes, followed by drying at 105° C. during 7 minutes and at 120° C. during 1 min. The thickness of the dried adhesive layer varies as is recorded in the examples. The dried coatings were irradiated with 65 mJ/cm² UV-C; measured with a Power Puck from EIT Inc.), using a medium pressure mercury lamp (available from TCS Technologies). After curing, the adhesives were laminated on a 50 μm thick nanoetched PET backing. The liner side was always used for measuring adhesive properties. Test specimen were prepared for the static shear and 180° peel adhesion (TM-1) as previously described. The test results are presented in Table 8.

TABLE 7

| Component (parts solids) | EX 20 | EX 21 | EX 22 | REF-2 |
|---|---|---|---|---|
| ACR POL | 100 | 100 | 100 | 100 |
| XL-POL | 0 | 1 | 1 | 1 |
| TACK 4 | 25 | 25 | 50 | 0 |

TABLE 8

| | Coating | 180° peel TM-1 | 180° peel TM-1 | RT shear on SS (20 |
|---|---|---|---|---|
| | thickness | (1 day dwell) on | (1 day dwell) on | min dwell), 1 kg/1 |
| Example | (μm) | FEP 6307 (N/dm) | PE-smooth (N/dm) | inch by 1 inch (min) |
| EX 20 | 45 | 8.4 | 18.3 | 269 |
| EX 21 | 55 | 14.6 | 15.7 | 10000+ |
| EX 22 | 55 | 7.5 | 21.6 | 5603 |
| REF-2 | 55 | 7.8 | 6.0 | 10000+ |

### Examples 23 to 25

In examples 23 to 25 low molecular weight fluorinated (meth)acrylate polymers, prepared from fluorinated methacrylate monomers comprising a carbamate linking group, were evaluated as tackifier in fluorinated PSA formulations. Therefore, 63% solids mixtures were prepared by blending 100 parts (solids) Fluoropolymer 6 (solubilized in acetone) with various fluorinated tackifiers in amounts as listed in table 9. No plasticizer was added. Adhesives layers were prepared from solution according to the procedure for making adhesive layers as given above. In all cases, clear coatings (60 m thickness) were obtained.

Test specimen were prepared for the static shear and 180° peel adhesion on stainless steel (TM-1) as previously described. The test results are presented in Table 9.

TABLE 9

| | | 180° peel TM-1 | RT shear on SS; 20 |
|---|---|---|---|
| | Tackifier | (1 day dwell) on | min dwell 1 kg/1″ × 1″ |
| Example | (parts) | SS (N/dm) | (min) |
| Ex 23 | TACK 12 (50) | 157.5 | 608 |
| Ex 24 | TACK 13 (50) | 62.2 | 1117 |
| Ex 25 | TACK 14 (50) | 93.3 | 1625 |

### Example 26 and 27

In examples 26 and 27 fluorinated PSA formulations were prepared from 63% solids mixtures prepared by blending 100 parts (solids) Fluoropolymer 5 (solubilized in acetone) with TACK 5 and Fluorinated plasticizer 1 in amounts as listed in table 10. Adhesives layers were prepared from solution according to the procedure for making adhesive layers as given above.

Test specimen were prepared for the static shear and 180° peel adhesion on stainless steel (TM-1) as previously described. The test results are presented in Table 10.

TABLE 10

| | Parts in composition | | | 180° peel TM-1 |
|---|---|---|---|---|
| | Fluoro- | | Fluorinated | (1 d dwell) on |
| Example | polymer 5 | TACK 5 | plasticizer 1 | PTFE (N/dm) |
| Ex 26 | 100 | 200 | 300 | 47.2 |
| Ex 27 | 100 | 300 | 100 | 47.2 |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will control.

1. Use of a low molecular weight fluorinated (meth)acrylate polymer as a tackifier in a pressure sensitive adhesive composition, wherein the low molecular weight fluorinated (meth)acrylate polymer comprises a plurality of pendent sulfonylamide groups.

2. The use according to claim 1, wherein the pressure sensitive adhesive composition comprises a high molecular weight polymer, having a at least one Tg, which is at most 0° C. and a number average molecular weight of at least 20 kilograms/mole.

3. The use according to claim 2, wherein the high molecular weight polymer is derived from a (meth)acrylate monomer.

4. The use according to claim 3, wherein the (meth)acrylate monomer comprises at least one of: iso-octyl acrylate, 2-octyl acrylate, 2-ethylhexyl acrylate, 2-propylheptyl acrylate, octadecyl acrylate, stearyl acrylate, butyl acrylate, 2-methyl butylacrylate, C18 acrylate derived from Guerbet alcohols, 2-hetpyl undecanyl acrylate, and combinations thereof.

5. The use according to claim 2, wherein the high molecular weight polymer is a fluoropolymer.

6. The use according to claim 2, wherein the adhesive composition comprises 10 to 400 parts of the low molecular weight fluorinated (meth)acrylate polymer per 100 parts of the high molecular weight polymer.

7. The use according to claim 1, wherein the low molecular weight fluorinated (meth)acrylate polymer has a glass transition temperature of −15° C. to 40° C.

8. The use according to claim 1, wherein the low molecular weight fluorinated (meth)acrylate polymer has a number average molecular weight of 0.5 to 10 kilograms/mole.

9. The use according to claim 1, wherein the low molecular weight fluorinated (meth)acrylate polymer comprises at least four and no more than 50 monomeric units.

10. The use according to claim 1, wherein the low molecular weight fluorinated (meth)acrylate polymer comprises a segment according to formula I: 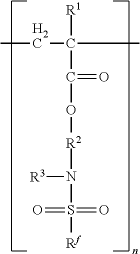
wherein R¹ is H or CH₃; R² is a linking group; R³ is H or an alkyl group; R_{f} comprises a perfluorinated group; and n is at least 2.

11. The use according to claim 1, wherein the low molecular weight fluorinated (meth)acrylate polymer is derived from a first monomer comprising a pendent sulfonylamide group and a second monomer, wherein the second monomer is selected from a (meth)acrylate.

12. The use according to claim 11, wherein the low molecular weight fluorinated (meth)acrylate polymer is derived from at least 50% by moles of the first monomer.

13. The use according to claim 1, wherein the high molecular weight polymer comprises a functional pendent group comprising at least one of —OH, —COOH, and combinations and salts thereof.

14. The use according to claim 1, wherein the low molecular weight fluorinated (meth)acrylate polymer comprises a plurality of pendent sulfonylamide groups further comprises a pendent group comprising at least one of —OH, —COOH, combinations and salts thereof.

15. The use according to claim 1, wherein the pressure sensitive adhesive composition is crosslinked.

16. The use according to claim 1, wherein the pressure sensitive adhesive composition further comprises a crosslinking agent.

17. The use according to claim 1, wherein the pressure sensitive adhesive composition further comprises a plasticizer.

18. A pressure sensitive adhesive composition comprising:
a high molecular weight polymer; and
10 to 400 parts of a low molecular weight fluorinated (meth)acrylate polymer per 100 parts of the high molecular weight polymer, wherein the low molecular weight fluorinated (meth)acrylate polymer comprises a plurality of pendent sulfonylamide groups to form a pressure sensitive adhesive.

19. A pressure sensitive adhesive composition according to claim 18 having dynamic mechanical properties measured at 25° C. such that
G′ measured at an angular frequency of 0.01 rad/s is greater than 1×10³ Pa,
G′ measured at an angular frequency of 100 rad/s is less than 1×10⁶ Pa,
G″ measured at an angular frequency of 0.01 rad/s is greater than 1×10³ Pa, and
G″ measured at an angular frequency of 100 rad/s is less than 1×10⁶ Pa.

20. A method of making a pressure sensitive adhesive, the method comprising: combining a low molecular weight fluorinated (meth)acrylate polymer having a plurality of pendent sulfonylamide groups with a high molecular weight polymer to form a pressure sensitive adhesive.
